(19) United States
(12) Patent Application Publication
(10) Pub. No.: US 2009/0163223 A1
(43) Pub. Date: Jun. 25, 2009

(54) LOAD BALANCING IN MOBILE ENVIRONMENT

(75) Inventor: Thomas CASEY, Espoo (FI)

Correspondence Address: YOUNG & THOMPSON, 209 Madison Street, Suite 500, ALEXANDRIA, VA, 22314, US

(73) Assignee: ELEKTROBIT WIRELESS COMMUNICATIONS LTD., Oulo (FI)

(21) Appl. No.: 11/962,329

(22) Filed: Dec. 21, 2007

(51) Int. Cl. H04Q 7/20

(52) U.S. Cl. 455/453

(57) ABSTRACT

In next generation wireless networks such as a Mobile WiMAX traffic prioritization is used to provide differentiated quality of service (QoS). Unnecessary ping-pong handovers that result from premature reaction to fluctuating radio resources pose a great threat to the QoS of delay sensitive connections such as VoIP which are sensitive to scanning and require heavy handover mechanisms. Traffic-class-specific variables are defined to tolerate unbalance in the radio system in order to avoid making the system slow to react to traffic variations and decreasing system wide resource utilization. By setting thresholds to trigger load balancing gradually in fluctuating environment the delay sensitive connections avoid unnecessary handovers and the delay tolerant connections have a chance to react to the load increase and get higher bandwidth from a less congested BS. A framework for the resolution of static user terminals in the overlapping area within adjacent cells will be described.

### TECHNICAL FIELD OF THE INVENTION

This invention relates to a method for balancing traffic load in a cellular radio system, a system and network element thereto.

### BACKGROUND OF THE INVENTION

When a base station in a cellular network gets congested, load balancing can be conducted by handing over mobile stations that reside in overlapping areas to other less congested base stations. This procedure is called base station initiated directed handover. Load balancing is usually triggered after a threshold in resource utilization has been passed. This is sufficient if the load difference between the base stations is big or the traffic and channel conditions are rather static. But if the radio system is close to being balanced or if the traffic offered is very fluctuating and radio channel varies a great deal, unnecessary load balancing handovers will be made. Consequently, the base stations bounce the traffic connection with the mobile station back and forth, hence inducing “ping-pong” phenomenon.

The disadvantage is that unnecessary handovers are especially bad for high priority real-time connections such as Voice over IP (VoIP) where a handover is a real threat for Quality of Service (QoS) guarantees. Such connections require a heavy handover mechanism, e.g. Macro Diversity Handover (MDHO) or Fast BS Switching (FBSS), to ensure reliable and fast handover execution and therefore unnecessary handovers should be avoided for them.

Referring to FIG. 1 there is depicted a base station controller 150 managing base stations 112, 114, 116 in a radio access network of a cellular radio system. Each base station 112, 114, 116 comprises a base transceiver station in order to handle functionality of radio path. Each base station 112, 114, 116 covers a certain coverage area, here denoted as a radio cell 102, 104, 106. Each user terminal 221-225, e.g. mobile station or portable computer, is connected to the radio system via the base station 112, 114, 116, and each base station 112, 114, 116 is connected to a core telecommunication network (not shown) via the base station controller 150. Some user terminals 222, 224 reside in the overlapping area between adjacent cells 102, 104, 106. The base station controller 150 is responsible for network controlled cell reselections (handovers) take place between different cells 102, 104, 106 of the radio system. The base station controller 150 monitors transmission power levels from base station 1 12, 114, 116 and physical load situation in the cell 102, 104, 106 of the base station 112, 114, 116. Degree of congestion in radio cells 102, 104, 106 is typically figured out by monitoring occupation of physical resources, e.g. resource utilization, in the radio system and as a result a resource utilization per radio cell 102, 104, 106 is achieved. Load balancing is usually triggered after a specific pre-set threshold has been passed in resource utilization. The base station controller 150 triggers the cell reselection in the cell 102, 104, 106 if the resource utilization exceeds the threshold. This load balancing triggering threshold per the radio cell can be set e.g. to an average base station resource utilization of the whole radio system or to a specific value with manual radio network planning.

FIG. 2a depicts degree of congestion in each base station 112, 114, 116 in the radio system. References U1, U2 and U3 denote a level of an instant resource utilization of total resources and illustrate load situation in the BSs 112, 114, 116, respectively. As can be seen from FIG. 2a the resource utilization of the BS 2 114 has passed the load balancing triggering threshold L, which is set to the average BS resource utilization and is same in each BS 112, 114, 116 in the system, and load balancing handovers will be conducted to the other BSs 112, 116. Since the load situation is already very close to being balanced, as a result of the handovers, the load of the other BSs 112, 116 might pass the threshold L and the connections will be handed over back to BS 2 114 resulting in a handover based ping-pong effect. In addition if the load situation and channel varies a great deal a fluctuation based ping-pong effect occurs between BSs 112, 114, 116 as shown by arrows in FIG. 2a. Both of these ping-pong effects can be partly solved by using the possibility to tolerate load unbalance by introducing a hysteresis margin after which load balancing is triggered.

As shown in FIG. 2b three possible load states for the BSs 112, 114, 116 are defined with relation to the total resources of the BS, namely underloaded, balanced and overloaded load states. The threshold L, which is set to be the average BS resource utilization, can be used to define a maximum level of the load state “underloaded”. The hysteresis margin dL is used to define how much traffic unbalance will be tolerated, and a new threshold L+dL can be used to define a maximum level of the load state “balanced”. When resource utilization U1, U2 or U3 reaches the area of the overloaded load state, the load balancing is triggered. This is because instead of the threshold L the new threshold L+dL is used as the load balancing triggering threshold. The overloaded load state area is defined as the area passing the threshold L+dL, where d characterizes the size of the hysteresis margin dL and can be set in relations to how variable the traffic and channel are predicted to be. The load state for the BS 112, 114, 116 is locally computed. The directed handovers are conducted only from BSs that are overloaded to BSs that are underloaded. In case of the load situation described in the FIG. 2b the directed handovers are conducted from BS 2 114 to BS 3 116 as shown by arrow. Admission of new connections in service flow level and directed handovers are denied in the overloaded load state. In the balanced load state new connections are allowed and in the underloaded load state new connections and directed handovers are allowed. As described above, the use of the threshold L+dL including the hysteresis margin dL as the load balancing triggering threshold reduces unnecessary handovers in the cellular radio system, such as WLAN network.

As described above to be able to avoid ping-pong handovers for some extent the hysteresis margin is used to define how much unbalance the cellular system will tolerate. On the other hand in a cellular network existing connections conducting a rescue handover to a new cell are often given higher priority and therefore affecting the load situation in radio cells.

While the scheme presented above brings relief the unnecessary handover problem to some degree it can not eliminate it totally. Unnecessary handovers will still be conducted and what's worse no differentiation between connection prioritization will be made. For efficient load balancing triggering the use of only single threshold (L or L+dL) is too coarse. Even though a hysteresis margin would be used, unnecessary directed handovers will occur if the traffic and the channel vary a great deal. Such ping-pong effect poses a real threat for the QoS of high priority real-time connections such as VoIP that require heavy handover mechanisms.

Traffic in the next generation mobile networks will be a mixture of real-time and non-real-time traffic including very fluctuating traffic such as User Datagram Protocol (UDP) based streaming video and elastic Transmission Control Protocol (TCP) based traffic. Also in many wireless communications systems, such as Mobile WiMAX, the Modulation and Coding Scheme (MCS) is adjusted according to the channel conditions of the radio link which will also cause a change in the resource utilization. The fluctuation problem can be addressed to some degree by using larger hysteresis margins or longer averaging periods. However if the hysteresis margin used is too large new connections (sessions) will be blocked, some connections will experience a drop in throughput and an increase in delay and hence the radio system wide resource utilization efficiency drops. Longer averaging periods make the system slow to react to changes causing also similar effects, because load balancing is conducted periodically based on predefined interval where average results are calculated. Therefore, the single threshold for load balancing triggering is not efficient enough in relation to system variables in dynamic environment.

### SUMMARY OF THE INVENTION

The problems set forth above are overcome by providing a load balancing scheme that takes into consideration a framework to differentiate between different priority connections. The idea is to make higher priority connections (e.g. VoIP) more robust against unnecessary handovers, resulting from traffic and channel fluctuation, than lower priority connections (e.g. HTTP). Firstly, due to load capacity increase a traffic-class-specific variable of the load capacity utilization is used to tolerate load unbalance in the radio system. Secondly, due to load capacity increase a traffic-class-specific variable of the load capacity resrevation is reserved to prioritize rescue handovers. These aspects should be taken into consideration when cell load balancing is triggered. This leads to better QoS without compromising the more efficient system wide resource utilization that load balancing brings in.

It is an objective of the invention to provide a load balancing scheme that takes instantaneous mobility of user terminals into consideration. Differentiated QoS connections to load balancing triggering is introduced in a mobile environment. By triggering load balancing in steps, load balancing handovers are conducted first for lower priority QoS connections with less stringent QoS guarantees and last for higher priority connections. In this way, load balancing with BS initiated directed handovers will be applied in the mobile network with a mixture of moving and static user terminals. It is a further objective of the invention to introduce different load balancing treatment for static and mobile user terminals in the mobile environment comprising a mixture of static and mobile user terminals.

The objectives of the invention are achieved by providing multiple thresholds for load balancing triggering in order to trigger load balancing gradually in resource fluctuating environments. Multiple thresholds are used to define different hysteresis margins and/or guard bands for different QoS classes which are also called traffic classes. This approach could be applied to resource utilization and/or resource reservation based load balancing triggering.

The invention is characterized by what is presented in the characterizing parts of the independent claims. Embodiments of the invention are presented in dependent claims.

The invention concerns a method for balancing load in a cellular network comprising a plurality of cells, the method comprising: measuring periodically load capacity of each adjacent cell overlapping at least partly within the plurality of cells, where at least one user terminal resides in an overlapping area of said adjacent cells, differentiating traffic connections of said at least one user terminal within each cell to at least two traffic classes based on at least delay sensitivity of the connection, comparing the load capacities in each of adjacent cells, where said at least one user terminal resides in the overlapping area of said adjacent cells, to define in each of the adjacent cells a load condition parameter comprising at least one load condition variable relating to the traffic class, setting a threshold for each of said traffic classes in relation to the load condition parameter, and triggering, upon extending the threshold, the traffic class having lower delay sensitivity before the traffic class having higher delay sensitivity to handle the connection of the user terminal further. If a terminal has two connections with different priorities, the load balancing triggering decision can be made based on the higher priority connection.

Preferably, a load condition parameter comprises at least information on load capacity changes in the radio system level and load capacity changes locally in each cell. Preferably, said information comprises average load capacity information and/or instantaneous load capacity information.

According to an embodiment of the present invention the load capacity refers to instantaneous utilized resources in each cell and the load condition parameter comprises an average resource utilization within each of said cells.

Preferably, the load condition parameter comprises a hysteresis margin as a traffic-class-specific variable.

According to another embodiment of the present invention the load capacity refers to reserved resources of each cell and the load condition parameter comprises instantaneous reserved resources within each of the adjacent cells.

Preferably, the load condition parameter comprises a guard band as a traffic-class-specific variable.

According to still another embodiment of the present invention a first load capacity refers to utilized resources in each cell and a second load capacity refers to reserved resources in each cell and a first load condition parameter comprises an average resource utilization within each of said adjacent cells and a second load condition parameter comprises instantaneous reserved resources within each of said adjacent cells.

Further the invention concerns a method for balancing load in a cellular network comprising a plurality of cells, the method comprising: measuring periodically load capacity of each adjacent cell overlapping at least partly within each other, where a plurality of user terminals reside in an overlapping area of said adjacent cells, differentiating traffic connections of said plurality of user terminals within each cell to at least two traffic classes based on at least delay sensitivity of the connection, comparing the load capacities in each of adjacent cells, where said plurality of user terminals reside in the overlapping area of said adjacent cells, to define in each of the adjacent cells a load condition parameter comprising at least one load condition variable relating to the traffic class, setting a threshold for each of said traffic classes in relation to the load condition parameter for a load balancing cycle, recognizing at least one static user terminal from said plurality of the user terminals residing in the overlapping area and triggering, upon extending the threshold, the traffic class connection having lower delay sensitivity before the traffic class connection having higher delay sensitivity to perform cell reselection of the at least one static user terminal further.

According to an embodiment of the present invention the at least one static user terminal from said plurality of the user terminals resides in the overlapping area throughout its whole session.

Further the invention concerns a system for balancing load in a cellular network comprising a plurality of base stations, each base station providing a cell for transmitting to and receiving from at least one user terminal, wherein the system is arranged to: measure periodically load capacity of each adjacent cell overlapping at least partly within the plurality of cells, where at least one user terminal resides in an overlapping area of said adjacent cells, differentiate traffic connections of said at least one user terminal within each cell to at least two traffic classes based on at least delay sensitivity of the connection, compare the load capacities in each of adjacent cells, where said at least one user terminal resides in the overlapping area of said adjacent cells, to define at least one load condition parameter in each of the adjacent cells, set a threshold for each of said traffic classes in relation to the load condition parameter, and trigger, upon extending the threshold, the traffic class having lower delay sensitivity before the traffic class having higher delay sensitivity to handle the connection of the user terminal further.

The invention also concerns a system for balancing load in a cellular network comprising a plurality of base stations, each base station providing a cell for transmitting to and receiving from at least one user terminal, wherein the system is arranged to: measure periodically load capacity of each adjacent cell overlapping at least partly within the plurality of cells, where at least one user terminal resides in an overlapping area of said adjacent cells, differentiate traffic connections of said at least one user terminal within each cell to at least two traffic classes based on at least delay sensitivity of the connection, compare the load capacities in each of adjacent cells, where said at least one user terminal resides in the overlapping area of said adjacent cells, to define at least one load condition parameter in each of the adjacent cells, set a threshold for each of said traffic classes in relation to the load condition parameter for a load balancing cycle, recognize at least one static user terminal from said plurality of the user terminals residing in the overlapping area, and trigger, upon extending the threshold, the traffic class having lower delay sensitivity before the traffic class having higher delay sensitivity to handle the connection of the static user terminal further.

According to an embodiment of the present invention the at least one static user terminal from said plurality of the user terminals resides in the overlapping area throughout its whole session.

Further the inventions concerns a network element for balancing load in a cellular network comprising a plurality of base stations, wherein each base station provides a cell for transmitting to and receiving from at least one user terminal, the network element comprising: measuring means arranged to measure periodically loading capacity of each cell overlapping at least partly within the plurality of cells, differentiating means arranged to differentiate traffic connections within each cell to at least two traffic classes based on at least delay sensitivity of the connection, comparing means arranged to compare the loading capacities of adjacent cells, where at least one user terminal resides in an overlapping area of said adjacent cells, to define a load condition in each of the adjacent cells, setting means to set a threshold for each of said traffic classes in relation to the load condition, and triggering means arranged to trigger, upon extending the threshold, the traffic class having lower delay sensitivity before the traffic class having higher delay sensitivity to perform cell reselection of the user terminal.

According to an embodiment of the invention the network element comprises means for recognizing at least one static user terminal from said plurality of the user terminals residing in the overlapping area, and trigger, upon extending the threshold, the traffic class having lower delay sensitivity before the traffic class having higher delay sensitivity to handle the connection of the static user terminal further.

Preferably, the at least one static user terminal from said plurality of the user terminals resides in the overlapping area throughout its whole session.

According to an embodiment of the present invention the network element comprises communicating means arranged to communicate between the adjacent cells.

Preferably, the network element resides in a radio resource agent entity.

The resource utilization and resource reservation based schemes both reduce the number of handovers conducted for delay sensitive connections while at the same time utilize the system wide resources in an efficient way. The multiple threshold load balancing triggering for different traffic classes is most efficient for packet level transmission in an environment where resource utilization fluctuates within the BSs but there is not a dramatic unbalance on the resource reservation level within the BSs. The multiple threshold load balancing triggering based on the resource reservation level is especially beneficial if traffic is rather static and/or the service flow level load difference between the BSs is clear, i.e. there is not a great chance for unnecessary ping-pong handovers. When resource utilization differs from resource reservation a great deal, these two schemes complement each other well making the system able to react on the level that is at the time most critical.

An additional advantage of using the multiple threshold load balancing triggering approach is that since the delay and jitter sensitive connections (e.g. VoIP) often reserve and use less bandwidth than more delay and jitter tolerant connections (e.g. streaming video with a large buffer or TCP based connections), handing over the more delay and jitter tolerant connections releases more resources in the congested BS and therefore even less handovers need to be conducted.

Various embodiments of the invention together with additional objects and advantages will be best understood from the following description of specific embodiments when read in connection with the accompanying drawings.

The embodiments of the invention presented in this document are not to be interpreted to pose limitations to the applicability of the appended claims. The verb “comprise” is used in this document as an open limitation that does not exclude the existence of also unrecited features. The features recited in depending claims are mutually freely combinable unless otherwise explicitly stated.

### BRIEF DESCRIPTION OF THE DRAWINGS

An embodiment of the invention will be described in detail below, by way of example only, with reference to the accompanying drawings, of which

FIG. 1 depicts a system for load balancing triggering according to prior art,

FIGS. 2a-2b depict a single threshold setting according to the prior art resulting to handover and fluctuation based ping-pong effect,

FIG. 3 depicts a system for load balancing triggering according to an embodiment of the invention,

FIG. 4 depicts a flow diagram of a method according to an embodiment of the invention,

FIG. 5 depicts another flow diagram of a method according to an embodiment of the invention,

FIG. 6 depicts another flow diagram of a method according to an embodiment of the invention,

FIG. 7 depicts an exemplary diagram of setting multiple thresholds in a method and system according to an embodiment of the invention,

FIGS. 8a-8b depict exemplary diagrams of setting multiple thresholds in a method and system according to an embodiment of the invention,

FIG. 9 depicts another exemplary diagram of setting multiple thresholds in a method and system according to an embodiment of the invention,

FIG. 10 depicts exemplary diagrams of setting multiple thresholds in a method and system according to an embodiment of the invention,

FIG. 11 depicts a flow diagram of setting multiple threshold in a method and system according to an embodiment of the invention,

FIGS. 12a-12b depict exemplary diagrams of setting multiple thresholds in a method and system according to an embodiment of the invention,

FIG. 13 depicts an exemplary flow diagram of setting multiple threshold in a method and system according to an embodiment of the invention,

FIG. 14 depicts another exemplary flow diagram of setting multiple threshold in a method and system according to an embodiment of the invention,

FIG. 15 depicts a flow diagram of recognition of at least one static terminal in the overlapping area in a method and system according to an embodiment of the invention,

FIG. 16 depicts an exemplary flow diagram of setting multiple threshold in a method and system according to an embodiment of the invention,

FIG. 17 depicts a block diagram of a system and network element according to an embodiment of the invention.

### DETAILED DESCRIPTION OF THE INVENTION

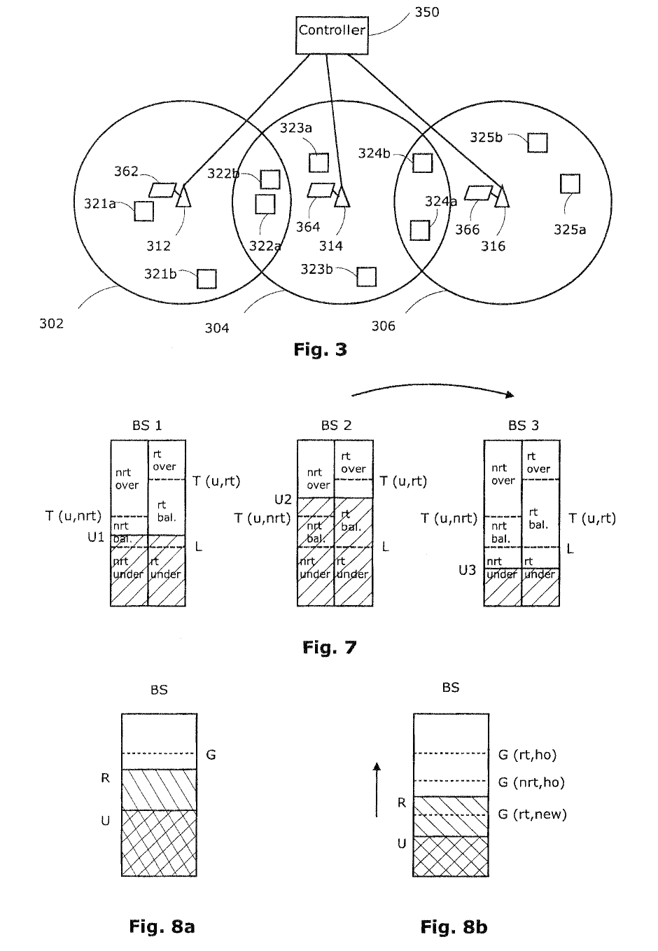

FIG. 3 depicts a radio system comprising a mixture of static user terminals 321a-325a and moving user terminals 321b-325b according to an embodiment of the invention. Each base station 312, 314, 316 comprises a base transceiver station in order to handle functionality of radio path. Each base station 312, 314, 316 covers a certain coverage area that is called here a radio cell 302, 304, 306. Each user terminal 321a-325a, 321b-325b, e.g. mobile station or portable computer, is connected to the radio system via the base station 312, 314, 316, and each base station 312, 314, 316 is connected to a core telecommunication network (not shown) via the base station controller 350. The controller 350 is responsible for network controlled cell reselections (handovers) to take place between different cells 302, 304, 306 of the radio system. In a system according an embodiment of the invention, a network element 362, 364, 366 residing in the base station 312, 314, 316 is responsible for initiating and controlling load balancing handovers to take place between different cells 302, 304, 306 of the radio system. Some of the user terminals 322a, 322b, 324a, 324b reside in the overlapping areas between adjacent cells 302, 304, 306. Those user terminals of the user terminals 322a, 322b, 324a, 324b that are likely to reside during the whole session (connection) in the overlapping areas of adjacent cells 302, 304, 306 are called in this specification static user terminals. Those user terminals of the user terminals 322a, 322b, 324a, 324b that move with a high velocity and are likely to move between the cells 302, 304, 306 are called in this specification mobile user terminals. The user terminal as such refers to both static and mobile user terminals in the overlapping areas as well as other user terminals 321a, 321b, 323a, 323b, 325a, 325b in general within adjacent cells 302, 304, 306.

Unnecessary ping-pong handovers that result from premature reaction to fluctuating radio resources pose a great threat to the QoS of delay sensitive connections such as VoIP which are sensitive to scanning and require heavy handover mechanisms. The simple solution where the averaging period is just increased, will make the system slow to react to traffic variations and decrease system wide resource utilization.

A better solution in such a fluctuating environment would be to trigger load balancing gradually, as resource utilization increases, first for the most delay tolerant connections, e.g. TCP based FTP, and last for the most delay sensitive connections, e.g. VoIP. This way the delay sensitive connections avoid unnecessary handovers and the delay tolerant connections have a chance to react to the load increase and get higher bandwidth from a less congested BS.

Traffic prioritization is a fundamental concept when offering differentiated QoS and it will be offered in next generation wireless networks such as Mobile WiMAX. According to the invention traffic prioritization is introduced in terms of load balancing. Multiple thresholds are used to define different hysteresis margins and/or guard bands for different QoS classes which are also called traffic classes. This approach could be applied to resource utilization and/or resource reservation based load balancing triggering.

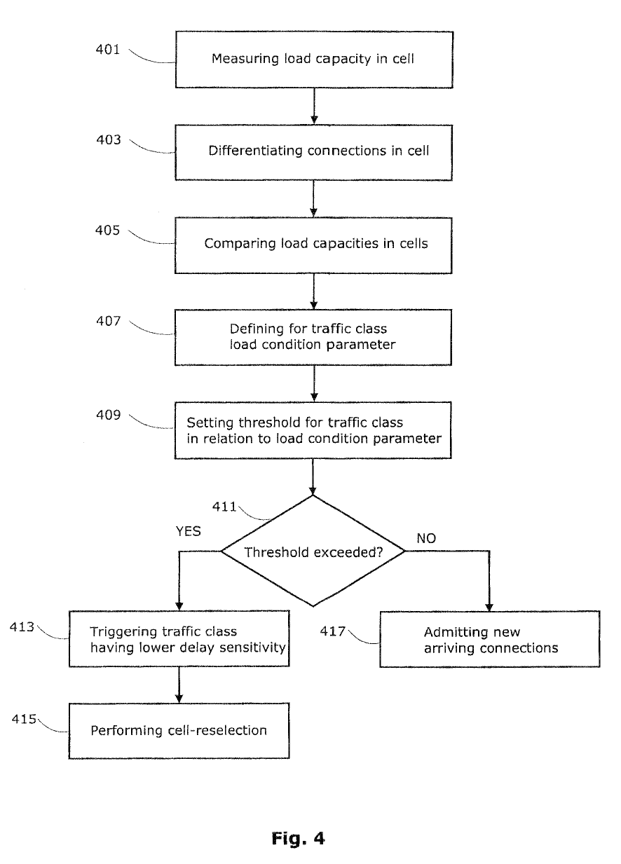

Referring to exemplary flow diagrams of FIGS. 4-6, a method according to some embodiments of the invention is described. It should be noted that all featured steps are not necessarily needed in every embodiment and that the order in which the steps are performed may vary.

In this application a load condition parameter comprises at least information on load capacity changes (e.g. due to traffic fluctuation) in the radio system level and load capacity changes locally in each cell as described later in more detail. Both average load capacity changes and instantaneous load capacity changes are included.

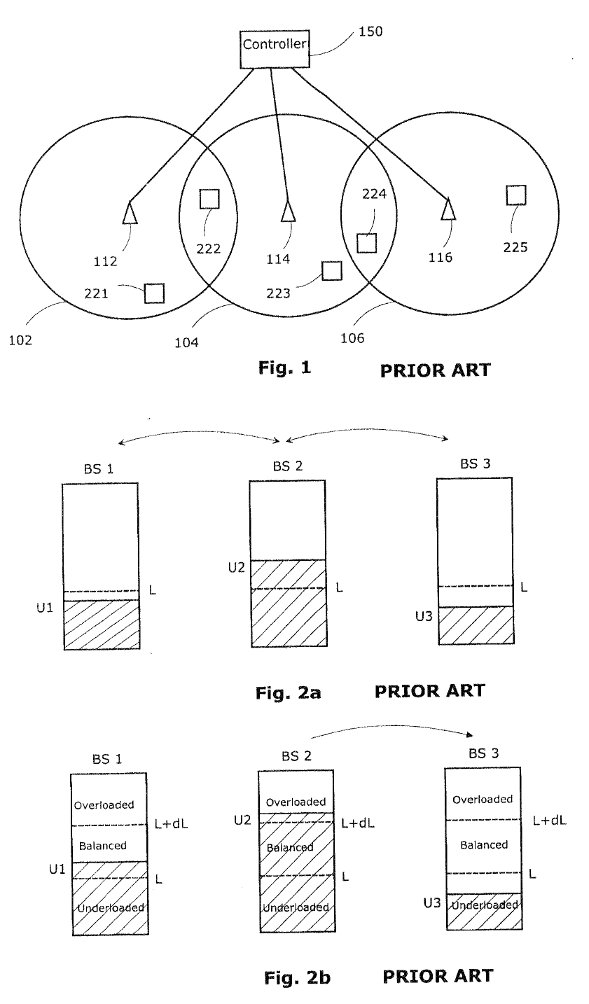

FIG. 4 depicts a flow diagram of a method for load balancing in a cellular network comprising a plurality of cells 302, 304, 306 according to an embodiment of the invention. In step 401 system radio load capacity is periodically measured in each cell 302, 304, 306 that are overlapping at least partly with its adjacent (neighbouring) cells. According to one embodiment of the invention the measured load capacity relates to instant proportion of utilized resources of the total resource utilization capacity allocated in the cell 302, 304, 306. In step 403 traffic connections within each cell 302, 304, 306 are differentiated according to traffic classes based delay sensitivity of the connection or based on delay and jitter sensitivity of the connection. According to the invention traffic connections are differentiated to at least two traffic classes. All traffic, e.g. packet and service flows, are carried on a connection, and the QoS depends on traffic class of the connection. Then in step 405 measured load capacities are compared in each adjacent cell 302, 304, 306 overlapping each other and where at least one user terminal 322a, 322b, 324a, 324b resides in the overlapping area. The load condition comprises information on load capacity changes as well as information on instant load condition in each cell 302, 304, 306 with respect to instantaneous total load capacity in the system to which said cells 302, 304, 306 belong. In addition the load condition comprises information on average load capacity of the cell 302, 304, 306 that is typically a mean value of the load capacity of the whole radio system divided by a number of cells 302, 304, 306 belonging to it. According to one embodiment of the invention the load condition comprises information on changes in radio resource utilization due to traffic and channel fluctuation, and instant resource utilization in each cell 302, 304, 306 and an average cell resource utilization with respect to total resource utilization of radio resources in the radio system. In step 407 based on measurements and comparisons a load condition parameter for each traffic class in each of the adjacent cells 302, 304, 306 is defined. In one embodiment the load condition parameter is based on the average load capacity of the cell 302, 304, 306 and certain load condition variables that are defined per each traffic class. The load condition variables comprises information that is either received directly through load capacity measurements or calculated using results from the load capacity measurements and therefore these variables are referring to the instantaneous load capacity of the cell 302, 304, 306. The load condition variables can also comprise predetermined values, e.g. a predefined interval for calculating certain averaging results. Next in step 409 a threshold for each traffic class will be set in relation to the load condition parameter. Therefore multiple thresholds are set depending on at least a number of traffic classes differentiated in step 403 (at least two traffic classes). In one embodiment the multiple thresholds are defined based on the load condition parameter comprising the average load capacity, e.g. average radio resource utilization, per the cell and load condition variables per each traffic class with relation to instantaneous load capacity, e.g. radio resource utilization and its variations. A traffic-class-specific variable is defined based on the load condition variables in order to tolerate some unbalance in the radio system. In one embodiment of the invention the traffic-class-specific variable is a hysteresis margin. Examples of possible ways to set multiple thresholds for each traffic class in order to trigger load balancing in the radio system will be discussed in more detail later in association with FIGS. 7 and 1 in this application. In step 411 depending on the instantaneous load capacity, i.e. due to increase of the load capacity in cell 302, 304, 306, there is checked whether the threshold for traffic class of the connection is exceeded. If the threshold is exceeded, then in step 413 load balancing is triggered for the connection of traffic class having lower delay sensitivity before the connection of traffic class having higher delay sensitivity in order to handle the connection further. In this way the load balancing will be triggered gradually to connections of different traffic classes. According to this embodiment as shown in step 415 the connection is handled further by performing a cell-reselection of the user terminal 322a, 322b, 324a, 324b residing in the overlapping area. The cell-reselection of the connection of the traffic class is performed into a target cell 302, 304, 306 of the BS being less congested with regard the same traffic class. Typically the instant load capacity in the target cell 302, 304, 306 is in an underloaded state as will be discussed later. According to one embodiment the underloaded state per traffic class is defined to be the load state in which the instant load capacity is below a level of the average load capacity per cell. Definitions of the load states will also be discussed later on. If in step 411 the threshold is not exceeded, then according to step 417 the cell 302, 304, 306 in question can admit new arriving connection of the traffic class having lower delay sensitivity as well as the traffic class having higher delay sensitivity. According to one embodiment of the invention in step 417 new lower delay sensitivity connections can be admitted, particularly if the admittance of the existing connections is protected. Next an embodiment of the invention depicted in FIG. 4 will be discussed in more detail in association with FIG. 7.

According to an embodiment of the invention a load balancing threshold triggering based on resource utilization U is presented in FIG. 7. There is exemplary depicted a multiple threshold scheme for load balancing triggering. In this example, let us assume that two traffic classes, namely delay tolerant non-real-time (nrt) and delay sensitive real-time (rt), are used connections within each BS and that a real-time connection is prioritized over non-real-time connection. By setting a separate hysteresis margin for both traffic classes multiple thresholds with respect to radio resource utilization U can be provided for load balancing triggering in order to trigger load balancing gradually in steps. These multiple thresholds are used to define corresponding load states of the traffic class in each BS. In the example of FIG. 7 there is defined for each BS two load balancing triggering thresholds T (u,nrt) and T (u,rt) with respect to radio resource utilization U. These thresholds T (u,nrt) and T (u,rt) are based on average system resource utilization L and a hysteresis margin that is specified for each traffic class based on load condition variables relating to radio system conditions. For example following load condition variables and their corresponding traffic-class-specific instances are taken into consideration alone or in any combination when defining the specified hysteresis margin: average system resource utilization fluctuation F (u,sys), maximum number of handovers h (max), maximum packet delay dt (max), maximum packet drops r (max), local resource utilization fluctuation F (u) and scheduler performance. The higher average and local system resource utilization fluctuation F (u,sys) are the higher hysteresis margin is specified. When a maximum number of handovers h (max) is passed the hysteresis margin is specified to be larger. When a maximum packet delay dt (max) and packet drops r (max) per traffic class is passed the hysteresis margin is specified to be narrower. These traffic load condition variables are discussed later more detail in this application.

As exemplary shown in FIG. 7 two load balancing thresholds T (u,nrt) and T (u,rt) are defined for each base station BS1, BS2, BS3 being adjacent to each other in the radio system. The threshold T (u,nrt) is based on average system resource utilization L and a hysteresis margin d1L that is specified for non-real-time traffic class, and T (u,nrt) is defined to equal to L+d1L in this example. As shown in FIG. 7 then corresponding load states for non-real-time traffic connections in each BS can be defined to be “non-real-time underloaded” when instant resource utilization U is below the average system resource utilization L, “non-real-time balanced” when instant resource utilization U is between L and the threshold T (u,nrt), and “non-real-time overloaded” when instant resource utilization U is above the threshold T (u,nrt). Respectively, the threshold T (u,rt) is based on average system resource utilization L and a hysteresis margin d2L that is specified for real-time traffic class, and T (u,rt) is defined to equal to L+d2L in this example. Then corresponding load states for real-time traffic connections in each BS can be defined to be “real-time underloaded” when instant resource utilization U is below the average system resource utilization L, “real-time balanced” when instant resource utilization U is between L and the threshold T (u,rt), and “real-time overloaded” when instant resource utilization U is above the threshold T (u,rt). The instant radio resource utilization U of each BS is U1 in BS1, U2 in BS2 and U3 in BS3. In this example the load balancing triggering threshold T (u,nrt) is reached in BS2 and therefore load balancing in BS 2, where non-real-time overloaded state now occurs, would be initiated only for the non-real-time traffic class connections. As shown by the arrow in FIG. 7, these non-real-time traffic class connections are handed over to BS 3 where the non-real-time underloaded state occurs. This means that load balancing handovers, i.e. BS initiated directed handovers, are conducted only for those user terminals (reference 324a, 324b in FIG. 3) residing in the overlapped area between cells (references 304, 306 in FIG. 3) that have non-real-time connections. If the load increase would be only temporary the delay and handover sensitive real-time connections would be spared from unnecessary handover. Furthermore if after a period of time, the load of BS 3 would temporarily increase, the non-real-time connections would be handed over back to the original cell. This “visit” would be beneficial to the non-real-time connections because they had access to a larger amount of bandwidth than what they would have had in the original BS. Also the handovers they experienced didn't affect their QoS or the system that much.

Although only two traffic classes are used in the example of FIG. 7, multiple threshold load balancing triggering can be applied to any number of traffic classes as long as they are prioritized based on delay and jitter sensitivity of the connection. A typical example of traffic class priority could be VoIP, streaming audio or video (having larger play out buffer than VoIP) and important FTP transfers. As an example, in Mobile WiMAX corresponding classes would be UGS (Unsolicited Grant Service) for VoIP connections or ErtPS (Extended Real-Time Polling Service) for voice with activity detection VoIP connections, rtPS (Real-Time Polling Service) for streaming audio or video connections and nrtPS (Non-Real-Time Polling Service) for FTP connections. For data transfer, web browsing, etc. connections Mobile WiMAX uses best-effort (BE) service traffic class as discussed later in this application.

There are several advantages of using the multiple threshold load balancing triggering according to the invention. Since VoIP and other delay and jitter sensitive connections often reserve and use less bandwidth than more delay and jitter tolerant connections (e.g. streaming video with a large buffer or TCP based connections), handing over the more delay and jitter tolerant connections releases more radio resources in the congested BS and therefore even less handovers need to be conducted. Furthermore VoIP based service flows require only a certain guaranteed rate and don't benefit from the extra bandwidth available in a less congested BS as much as more delay and jitter tolerant streaming video connections and TCP based connections do. In case of traffic congestion, the QoS of more delay and handover tolerant classes will degrade first before more delay and handover sensitive classes (nrt before rt), making the more delay and handover tolerant classes also in this sense more critical to be handed over to the less congested cell. Also the fact that arriving rescue handovers require a heavy execution mechanism has to be taken into account in the BS. Because the arriving rescue handovers therefore leave less handover capacity in the BS, consequently the BS initiated directed handovers should be minimized for the delay and jitter sensitive connections.

In addition to prioritization of different traffic classes as discussed above also certain prioritization within traffic classes would be possible. Prioritization within traffic classes can be made independently on prioritization of different traffic classes. For example traffic prioritization within the delay tolerant classes could be used so that a higher priority FTP connection would be handed over before a lower priority FTP connection, so that it would have access to more bandwidth.

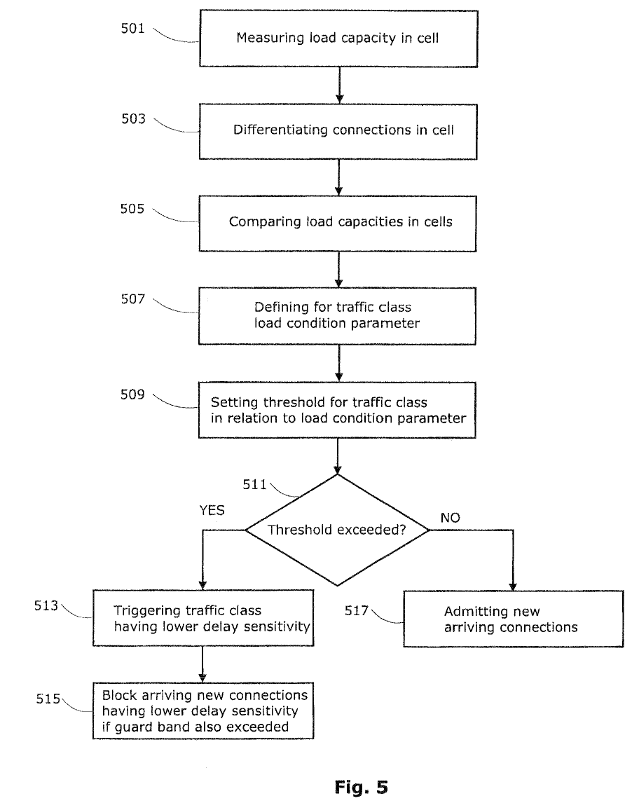

An embodiment of multiple threshold load balancing triggering for different traffic classes as described above is most efficient for packet level transmission in an environment where resource utilization U fluctuates within the BSs but there is not a dramatic unbalance on the resource reservation level within the BSs. Next another embodiment of multiple threshold load balancing triggering is discussed with reference to FIG. 5 where triggering balancing is based on the resource reservation level. This latter embodiment of the invention is especially beneficial if traffic is rather static and/or the service flow level load difference between the BSs is clear, i.e. there is not a great chance for unnecessary ping-pong handovers. When resource utilization differs from resource reservation a great deal, the resource reservation based scheme complements the resource utilization scheme well making the system able to react on the level that is at the time most critical.

FIG. 5 depicts a flow diagram of a method for load balancing in a cellular network comprising a plurality of cells 302, 304, 306 according to another embodiment of the invention. In step 501 system radio load capacity is periodically measured in each cell 302, 304, 306 that are overlapping at least partly with its adjacent cells. According to one embodiment of the invention the measured load capacity relates to instant proportion of reserved resources of the total resource reservation capacity allocated in the cell 302, 304, 306. In step 503 traffic connections within each cell 302, 304, 306 are differentiated according to traffic classes based delay sensitivity of the connection or based on delay and jitter sensitivity of the connection. According to the invention traffic connections are differentiated to at least two traffic classes.

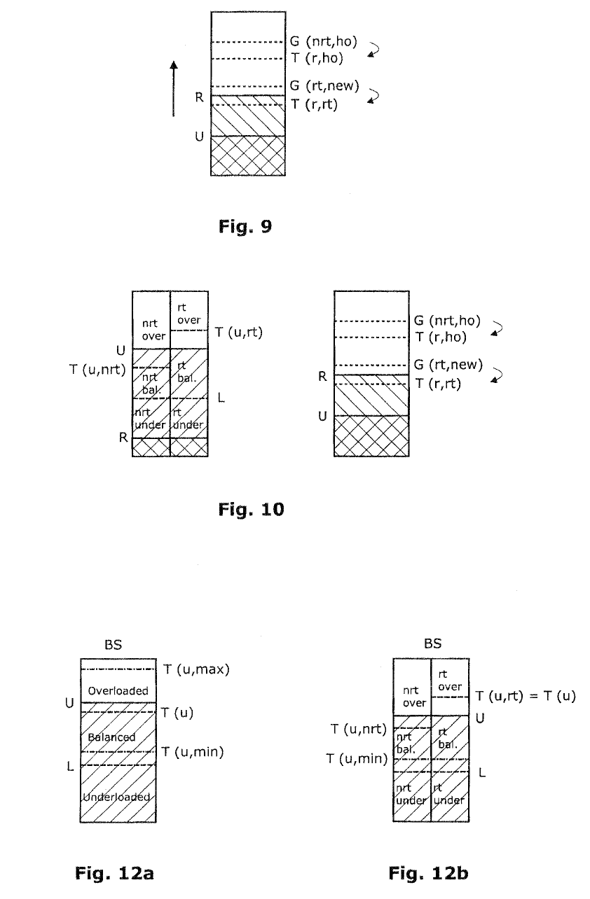

According to one embodiment of the invention in addition to differentiating traffic connections according to traffic classes, traffic classes can be also differentiated within each traffic class for new and handover traffic connections. All traffic, e.g. packet and service flows, are carried on a connection, and the QoS depends on traffic class of the connection. Then in step 505 measured load capacities are compared in each adjacent cell 302, 304, 306 overlapping each other and where at least one user terminal 322a, 322b, 324a, 324b resides in the overlapping area. The load condition comprises information on load capacity changes as well as information on instant load condition in each cell 302, 304, 306 with respect to instantaneous total load capacity in the system to which said cells 302, 304, 306 belong. In addition the load condition comprises information on reserved load capacity of the cell 302, 304, 306 with respect to total reserved load capacity that is dynamically or fixed reserved for protecting rescue handover connections or higher priority traffic from the adjacent cells 302, 304, 306, i.e. protecting load capacity. According to one embodiment of the invention the load condition comprises information on changes in radio resource reservation, and instant resource reservation in each cell 302, 304, 306 and the protecting resource reservation with respect to total resource reservation of radio resources in the radio system. In step 507 based on measurements and comparisons a load condition parameter for each traffic class in each of the adjacent cells 302, 304, 306 is defined. In one embodiment the load condition parameter is based on the protecting load capacity of the cell 302, 304, 306 that is defined dynamically (or fixed) for each traffic class and certain load condition variables that are defined per each traffic class as well. The load condition variables comprises information that is either received directly through load capacity measurements or calculated using results from the load capacity measurements and therefore these variables are referring to the instantaneous load capacity of the cell 302, 304, 306. The load condition parameter comprises also information on mobility patterns of the user terminals 322a, 322b, 324a, 324b residing in the overlapping area as explained later. The load condition variables can also comprise predetermined values. Next in step 509 a threshold for each traffic class will be set in relation to the load condition parameter. Therefore multiple thresholds are set depending on at least a number of traffic classes for existing, new and handover traffic connections differentiated in step 503 (at least three thresholds). In one embodiment the multiple thresholds are defined based on the load condition parameter comprising the protecting load capacity, e.g. protecting radio resource reservation per the traffic class and load condition variables per each traffic class with relation to instantaneous load capacity, e.g. radio resource reservation and its variations. The load condition variables comprises a traffic-class-specific variable intended to protect rescue handover connections in the radio system. In one embodiment of the invention such a traffic-class-specific variable is a guard band. The load condition variables comprises also information on mobility of the user terminal 322a, 322b, 324a, 324b residing in the overlapping areas within the adjacent cells 302, 304, 306. How to set multiple thresholds for each traffic class in order to trigger load balancing in the radio system will be discussed in more detail later in association with FIGS. 8 and 12. In step 511 depending on the instantaneous load capacity, i.e. due to increase of the load capacity in cell 302, 304, 306, there is checked whether the threshold for traffic class of the connection is exceeded. If the threshold is exceeded, then in step 513 load balancing is triggered for the connection of traffic class having lower delay sensitivity before the connection of traffic class having higher delay sensitivity in order to handle the connection further. In this way the load balancing will be triggered gradually to connections of different traffic classes. According to this embodiment as shown in step 515 the connection is handled further by blocking an arriving new connection of the user terminal 322a, 322b, 324a, 324b residing in the overlapping area the new connection having lower delay sensitivity if the corresponding guard band is also exceeded. However, an arriving handover connection having lower delay sensitivity can be admitted if any protecting load capacity for the same traffic class is allowable. The blocked new connections of different traffic classes can be buffered in a target cell 302, 304, 306 in order to queue “free” load capacity. If in step 511 the threshold is not exceeded, then according to step 517 the cell 302, 304, 306 in question can admit new arriving connection of the traffic class having lower delay sensitivity as well as the traffic class having higher delay sensitivity. Next an embodiment of the invention described above with reference to FIG. 5 will be presented in more detail in association with FIGS. 8a, 8b and 9.

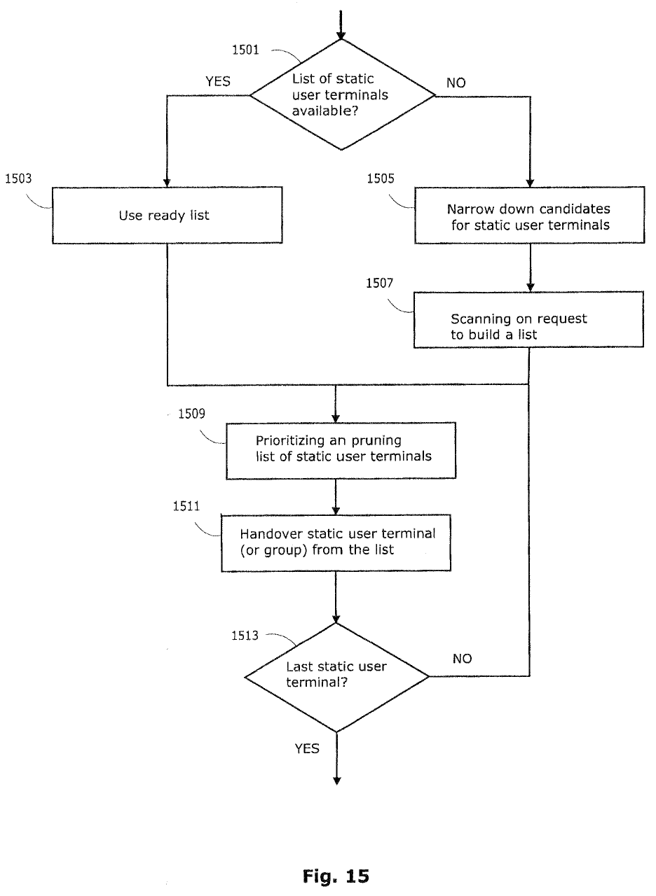

According to one embodiment of the invention load balancing in a mobile environment, as shown in FIG. 3, it might be beneficial to conduct load balancing only for static user terminals of the user terminals 322a, 322b, 324a, 324b that are likely to reside during the whole session in the overlapping areas of adjacent cells 302, 304, 306. Mobile user terminals of the user terminals 322a, 322b, 324a, 324b that move with a high velocity are likely to move between the cells 302, 304, 306 and therefore rescue handovers are conducted during their session. This would result in unnecessary handovers if load balancing were conducted for fast moving mobile user terminals that reside in the overlapping area at the time when load balancing was triggered but are likely to move out from the overlapping area. Typically rescue handovers are even more challenging to execute than directed handovers and therefore they reserve a lot of resource capacity. Therefore, according to this embodiment of the invention the load balancing triggering is applied for static user terminals in the mobile network comprising a mixture of static and mobile user terminals. The static user terminal can be differentiated from mobile user terminals by measuring mobility patterns of the user terminals 322a, 322b, 324a, 324b residing in the overlapping areas within the adjacent cells 302, 304, 306. During scanning process these measurements produce e.g. information on radio distance, round trip delay, location information, and channel and round trip delay variation. This information is included in the load condition variables as described above and is therefore included in the load condition parameter that the threshold setting is based on. After initiating load balancing the base station will have to find out which user terminals are static and in the overlapping area. In a method according to an embodiment of the invention a step of recognizing static terminals is performed either before the step 413 of FIG. 4A (before step 513 of FIG. 5) or between steps 413 and 415 of FIG. 4 (between steps 513 and 515 of FIG. 5). Alternatively, a predetermined list of static terminals can be used. A framework for the resolution of static terminals from the plurality of user terminals in the overlapping area will be discussed later in more detail in connection with FIG. 15.

When user terminals migrate from one cell to another cell a guard band has to be reserved so that the connection of the user terminal won't be dropped. In a cellular radio system it is commonly accepted that dropping an existing connection is worse than blocking a new one. The existing connections conducting a rescue handover to a new cell are given higher priority than new connections that are requesting to establish connection for communication. This is done by reserving for incoming rescue handovers a guard band of the radio resources.

FIG. 8a shows generally a guard band G that is reserved for arriving rescue handovers in the BS 312, 314, 316. The guard band G is defined in terms of the reserved radio resources R of the BS, not the used radio resources U as in case of the hysteresis margin. Reserved resources R correspond to service flow level arrivals and slot holding times whereas utilized resources U correspond to traffic load on the packet level. Resource utilization U can temporarily be larger than resource reservation R but what is more important, as depicted in FIG. 8a, the resource reservation R (all resource area below R) might be higher than what the resource utilization U (resource area below U) indicates. If the guard band G in resource reservation R is passed new connections are not admitted and they have to queue admittance, and eventually new connections will be blocked if the admittance does not succeed during predetermined time period. Therefore it's important to be able to react to traffic load on both service flow and packet levels and trigger load balancing on the level that is most critical.

When triggering load balancing in this situation the guard band G should be taken into consideration. The guard band G can be dynamic or fixed. The guard band G can be adjusted dynamically with relation to load condition variables comprising a rescue handover arrival rate and connection (session) lengths of the user terminal. In the next generation mobile networks, base stations are likely to be self-organized and optimized so a dynamic scheme where the guard band is tuned according to mobility patterns will be used making resource reservation based load balance triggering in relations to the guard band G even more important. Alternatively, if the guard band G is fixed with relation to reserved resources R new connections are throttled when the rescue handover rate to the BS 312, 314, 316 is increasing.

Prioritization can be realized by a dynamic multiple-threshold bandwidth reservation (DMTBR) scheme that uses a guard band for handovers while maintains relative priorities for different traffic classes. FIG. 8b shows as an example multiple thresholds for traffic prioritization according to the dynamic multiple-threshold bandwidth reservation. It is capable of granting differential priorities not only to connections of different traffic classes but also to connections of new and handover traffic for each class by dynamically adjusting multiple bandwidth reservation thresholds. A number of thresholds in the dynamic multiple-threshold bandwidth reservation depends on the level how QoS is desired to be differentiated and therefore a number of defined traffic classes to be prioritized for excisting and new traffic connections. The dynamic multiple-threshold bandwidth reservation works locally in the BS. The BS estimates initial values for the thresholds based on instantaneous mobility and traffic load situation. The thresholds are further adapted according to instantaneous QoS measures such as dropped handovers and blocked new calls. The definition of appropriate threshold values will be discussed later more detail in this description.

FIG. 8b depicts an example of the dynamic multiple-threshold bandwidth reservation procedure comprising three bandwidth reservation thresholds. There is shown how resources are prioritized in BS for different types of arriving rescue handovers and new calls. In this example three bandwidth reservation thresholds with relation to instantaneous reserved resources can be defined for traffic prioritization, by using following guard bands: a guard band G (rt,new) for new real-time connections, a guard band G (nrt, ho) for non-real-time handovers and a guard band G (rt, ho) for real-time handovers. The guard band G (rt,new) can for example be used for changes in modulation and coding scheme (MCS) to ensure sufficient radio resources for the higher priority connections when channel conditions degrade. This may happen when the user terminal is moving away from the BS and for link adaptation more robust MCS is chosen and therefore more resources are needed. When resource reservation R increases as shown by an arrow in FIG. 8b, the resources reserved after the guard band G (rt,new) can be used by new real-time connections, non-real-time handovers and real-time handovers. All new non-real-time connections will be blocked after the guard band G (rt, new) has been passed when instant resource reservation R has reached the level as shown in FIG. 8b. New non-real-time connections are admitted only below the guard band G (rt, new) of reserved resources. In the same way the resources reserved after the guard band G (nrt, ho) can be only used by non-real-time handovers and real-time handovers. All new real-time connections will be blocked after the guard band G (nrt, ho) has been passed and they are admitted only below the guard band G (nrt, ho) of reserved resources. Finally, the resources reserved after the guard band G (rt, ho) can only be used by real-time handovers. All non-real-time handovers will be blocked after the guard band G (rt, ho) has been passed, as well as new real-time and non-real-time connections.

According to another embodiment of the invention a load balancing threshold triggering based on resource reservation R is shown in FIG. 9. As an example there is applied the dynamic multiple-threshold bandwidth reservation procedure, as discussed in association with FIGS. 8a and 8b, where bandwidth reservation thresholds with relation to instantaneous reserved resources R are defined for traffic prioritization, namely using a guard band G (rt,new) for new real-time connections and a guard band G (nrt, ho) for non-real-time handovers. FIG. 9 shows load balancing threshold triggering based on resource reservation R that prioritizes delay sensitive real-time connections over delay tolerant non-real-time connections. For different traffic classes multiple triggering thresholds are set in order to trigger load balancing gradually. The basic idea is to trigger load balancing first for the non-real-time connections as was done with the resource utilization based load balancing threshold triggering as discussed earlier in this description. This further reduces the number of unnecessary handovers conducted for delay sensitive connections.

According to an embodiment of FIG. 9 as an example the triggering thresholds T (r,ho) and T (r,rt) are set so that load balancing will be triggered to the real-time and non-real-time traffic classes. The guard band G (rt, new) protects new real-time connections and if it is exceeded new non-real-time connections will be blocked and thus T (r,rt) will trigger load balancing for the non-real-time connections. Respectively, the guard band G (nrt, ho) protects rescue handover non-real-time connections and if it is exceeded new real-time connections will be blocked and thus T (r,ho) will trigger load balancing for the real-time connections. The triggering thresholds T (r,ho) and T (r,rt) are defined so that load balancing will not trigger too early to avoid premature reaction and unnecessary handovers but not too late to avoid new connection blocking. There may also be temporary peaks on the service flow level due to e.g. rapid MCS changes that should be taken into account. With respect to resource reservation R the triggering threshold T (r,ho) is adjusted in relation to the guard band G (nrt,ho) that is specified for non-real-time traffic class in this example. Respectively the triggering threshold T (r,rt) is adjusted in relation to the guard band G (rt,new) that is specified for real-time traffic class in this example. When defining triggering thresholds T (r,ho) and T (r,rt) in addition to corresponding guard bands and possibly average resource reservation in the system if available following load condition variables and their corresponding traffic-class-specific instances relating to radio system conditions should be taken into consideration alone or in any combination: instantaneous and/or average slot reservation rate λ (res), instantaneous and/or average slot holding time t (s), load balancing slot release rate λ (rel), maximum call blocking rate b (max) and/or maximum queueing time q (max), maximum number of handovers h (max), local resource reservation level fluctuation F (r) and average resource reservation fluctuation F (r,sys) in the system. The maximum call blocking rate b (max) and maximum queuing time q (max) indicate the case where handovers were triggered too late and the maximum number of handovers h (max) indicates unnecessary handover rate when handovers were triggered too early. High handover rate h, F (r) or λ (rel) delays the threshold and high blocking rate b, queuing time q, λ (res) and t (s) advances the threshold. Tuning the threshold with these variables properly problems caused by too early or too late load balancing triggering are avoided as well as temporary peaks on the service flow level are taken into account. These traffic load condition variables relating to resource reservation are discussed later in this application in more detail.

According to one embodiment of the invention the resource reservation triggered load balancing handovers can be treated as new connection calls in a less congested receiving BS so that the resource reservation burden is distributed across the radio system and as many new connections as possible can be admitted in the BS. Furthermore a similar hysteresis margin based approach as is used in the resource utilization based scheme can be applied here to avoid the handover based ping-pong effect.

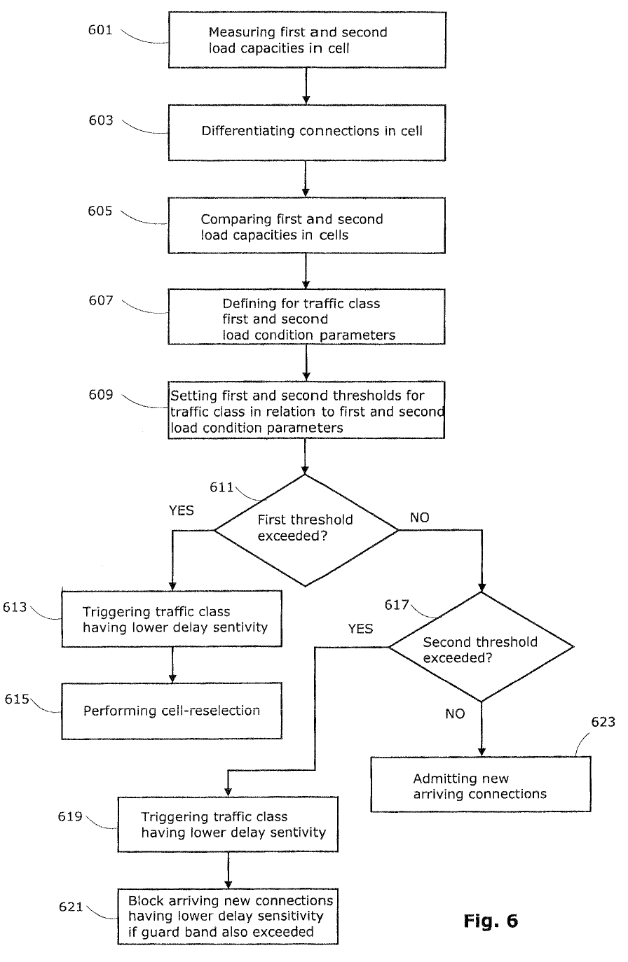

FIG. 6 depicts a flow diagram of a method for load balancing in a cellular network comprising a plurality of cells 302, 304, 306 according to still another embodiment of the invention. In step 601 system radio load capacity comprising a first load capacity and a second load capacity is periodically measured in each cell 302, 304, 306 that are overlapping at least partly with its adjacent cells. According to one embodiment of the invention the first load capacity relates to instant proportion of utilized resources of the total resource utilization capacity allocated in the cell 302, 304, 306 and the second the load capacity relates to instant proportion of reserved resources of the total resource reservation capacity allocated in the cell 302, 304, 306 and. In step 603 traffic connections within each cell 302, 304, 306 are differentiated according to traffic classes based delay sensitivity of the connection or based on delay and jitter sensitivity of the connection. According to the invention traffic connections are differentiated to at least two traffic classes. In addition to differentiating traffic connections according to traffic classes, traffic classes can be also differentiated within each traffic class for new and handover traffic connections. Then in step 605 the first load capacities are compared in each adjacent cell 302, 304, 306 overlapping each other and where at least one user terminal 322a, 322b, 324a, 324b resides in the overlapping area, and the second load capacities are compared respectively. The load condition with regard to the first load capacity comprises information described in association with description referring to FIG. 4, and the load condition with regard to the second load capacity comprises information described in association with description referring to FIG. 5. In step 607 based on measurements and comparisons a first load condition parameter and a second load condition parameter for each traffic class in each of the adjacent cells 302, 304, 306 is defined. In one embodiment the first load condition parameter is based on the average load capacity of the cell 302, 304, 306 and certain first load condition variables that are defined per each traffic class, and the second load condition parameter is based on the protecting load capacity of the cell 302, 304, 306 that is defined dynamically for each traffic class and certain load condition variables that are defined per each traffic class. The first load condition variables comprise information described in association with description referring to FIG. 4, and the second load condition variable comprise information described in association with description referring to FIG. 5. Next in step 609 a first threshold for each traffic class will be set in relation to the first load condition parameter and a second threshold for each traffic class will be set in relation to the second load condition parameter. How to set multiple first thresholds and multiple second thresholds for each traffic class in order to trigger load balancing in the radio system will be discussed in more detail later in association with FIGS. 10, 11 and 12 in this application. In step 611 depending on the instantaneous load capacity, i.e. due to increase of the load capacity in cell 302, 304, 306, there is checked whether the first threshold for traffic class of the connection is exceeded. If the first threshold is exceeded, then in step 613 load balancing is triggered for the connection of traffic class having lower delay sensitivity before the connection of traffic class having higher delay sensitivity in order to handle the connection further. In this way the load balancing will be triggered gradually to connections of different traffic classes. According to this embodiment as shown in step 615 the connection is handled further by performing a cell-reselection of the user terminal 322a, 322b, 324a, 324b residing in the overlapping area. The cell-reselection of the connection of the traffic class is performed into a target cell 302, 304, 306 of the BS being less congested with regard the same traffic class. Typically the instant load capacity in the target cell 302, 304, 306 is in an underloaded state as discussed earlier. If in step 611 the first threshold is not exceeded, then in step 617 there is checked whether the second threshold for traffic class of the connection is exceeded. If the second threshold is exceeded, then in step 619 load balancing is triggered for the connection of traffic class having lower delay sensitivity before the connection of traffic class having higher delay sensitivity in order to handle the connection further. In this way the load balancing will be triggered gradually to connections of different traffic classes. According to this embodiment as shown in step 621 the connection is handled further by blocking an arriving new connection of the user terminal 322a, 322b, 324a, 324b residing in the overlapping area, the new connection having lower delay sensitivity if the corresponding guard band is also exceeded. If in step 617 the second threshold is not exceeded then according to step 623 the cell 302, 304, 306 in question can admit new arriving connection of the traffic class having lower delay sensitivity as well as the traffic class having higher delay sensitivity. Alternatively, according to one embodiment of the invention step 617 can change place with step 611 in order to check the second threshold for load balancing triggering before checking the first threshold. All other steps following steps 611 or 617 remain the same as earlier explained. In one embodiment of a method according to the invention a first load capacity refers to resource utilization and a second load capacity refers to resource reservation. In another embodiment of a method according to the invention a first load capacity refers to resource reservation and a second load capacity refers to resource utilization. Next an embodiment of the invention depicted in FIG. 6 will be presented in more detail in association with FIG. 10.

According to an embodiment of the invention a load balancing threshold triggering based on both resource utilization U and resource reservation R is presented in FIG. 10. This combined load balancing threshold triggering based on resource utilization U and resource reservation R prioritizes delay sensitive real-time connections over delay tolerant non-real-time connections. For different traffic classes multiple triggering thresholds comprising, e.g. load balancing thresholds T (u,mt), T (u,rt), T (r,ho) and T (rt,new), are set for each BS in the radio system in order to trigger load balancing gradually. A number of thresholds is not limited to any examples presented in this application. Also in this embodiment the basic idea is to trigger load balancing first for the non-real-time connections as was done with the resource utilization based load balancing threshold triggering and the resource reservation based load balancing threshold triggering as discussed earlier in this application. As earlier described the resource utilization and resource reservation based load balancing threshold triggering both reduce the number of handovers conducted for delay sensitive connections while at the same time utilize the system wide resources in an efficient way. According to one embodiment of the invention the combined load balancing threshold triggering is especially usable in a mobile network that uses different traffic classes, prioritizes handover and delay sensitive traffic and whose radio resource usage fluctuates a great deal, because then the load balancing threshold triggering reacts to instant loading situation on the traffic level that is at the time most critical.

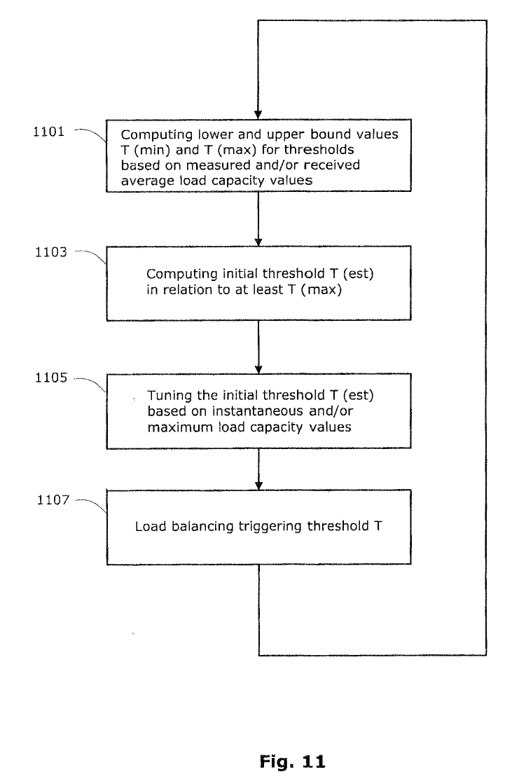

Determination of multiple thresholds for load balancing triggering will be described now in more detail. According to the invention a threshold for each traffic class is set in relation to the load condition that comprises information on load capacity changes as well as information on instantaneous load condition received from periodical measurements of the radio system as earlier discussed. FIGS. 11-14 depict flow diagrams how the thresholds for load balancing triggering, on both resource utilization and reservation level, could be self-configured by the BS using the above-mentioned measurement results and how they could be further tuned. The thresholds are dynamically adjusted based on the current traffic characteristics of the radio system.

Next with reference to FIG. 11 there will be discussed in more detail how to set multiple thresholds for load balancing triggering in relation to the load condition parameter. The load condition parameter is defined in steps 407, 507 and 607 of FIGS. 4, 5 and 6 respectively, and it is used in step 409, 509 and 609 of FIGS. 4, 5 and 6 respectively. The load condition parameter comprises at least information on load capacity changes (fluctuation) in the radio system level, e.g. load capacity values F (sys), F (u, sys), F (r, sys), and load capacity changes in each cell, e.g. load capacity values F, F (u) and F (r), as described next in this description. Both resource utilization U and resource reservation R based load capacity balance triggering is described referring to FIG. 11.

FIG. 11 depicts a flow diagram of a method according to an embodiment of the invention for setting multiple thresholds in relation to load capacity. In step 1101 two boundary values, namely a lower bound reference value T (min) and an upper bound reference value T (max) are computed based on average load capacity values. These average load capacity values are measured periodically in the radio system locally in the base station or they are received from the base station controller to the base station. Alternatively, part of these average load capacity values are measured periodically in the radio system locally in the base station and part of them are received from the base station controller to the base station in question. Alternatively, part of these average load capacity values are measured periodically in the radio system locally in the base station and part of them are received from other adjacent base stations to the base station in question. Next in step 1103 an initial threshold estimate T (est) is calculated in relation to at least the upper bound reference value T (max). In addition other load condition variables relating to average load capacity values of the base station are taken into account as will be explained later in more detail. Then in step 1105 the initial threshold T (est) is tuned and computed based on instantaneous load capacity values and/or maximum load capacity values that are measured and/or received in the base station. These instantaneous and/or maximum load capacity values are measured periodically in the radio system locally in the base station or they are received from the base station controller to the base station. Alternatively, part of these average load capacity values are measured periodically in the radio system locally in the base station and part of them are received from the base station controller to the base station in question. Alternatively, part of these average load capacity values are measured periodically in the radio system locally in the base station and part of them are received from other adjacent base stations to the base station in question. Step 1107 shows the threshold T for load balancing triggering that is used for the rest of the periodic cycle if no further tuning is required.

In a method according to an embodiment of the invention the load capacity values comprising instantaneous load capacity values and/or maximum load capacity values are measured locally in each base station, and the load capacity values comprising average load capacity values are calculated locally in each adjacent base station based on instantaneous load capacity values received from other adjacent base stations. According to an embodiment of the invention each adjacent base station is able to communicate with other adjacent base stations by sending and receiving messages comprising information about load capacity values. As an example of such message is a spare capacity report (SCR) that allows resource utilization U based load capacity exchange between adjacent base stations in Mobile WiMAX networks. According to another example by specifying additional fields to the SCR message it allows resource reservation R based load capacity exchange between between adjacent base stations in Mobile WiMAX networks as well.

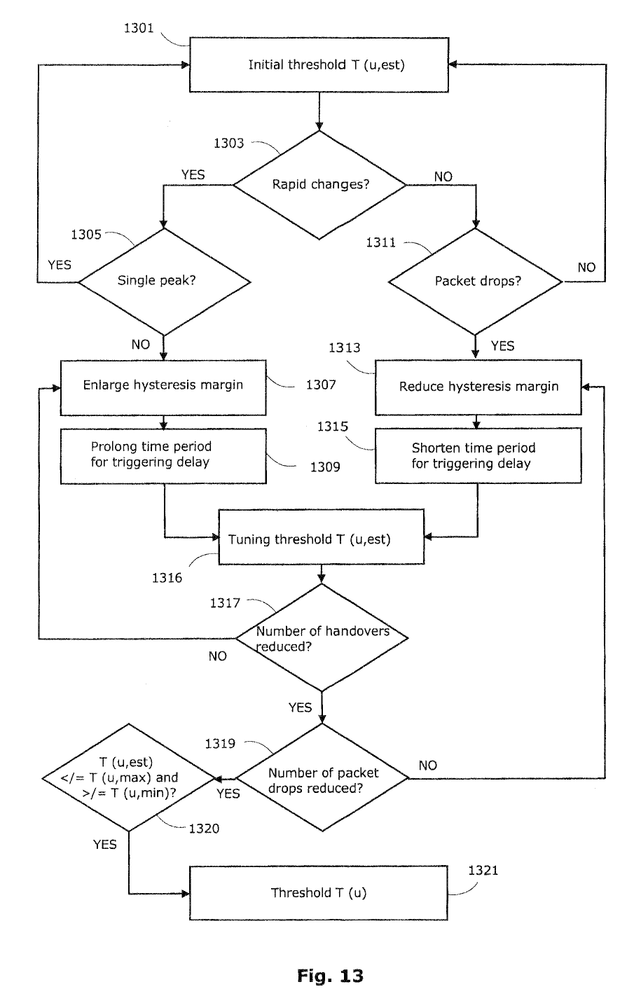

In a method according to an embodiment of the invention multiple thresholds are set in relation to load capacity of resource utilization U in the base station and in the system. In step 1101 a lower bound reference value T (u,min) and an upper bound reference value T (u,max) are computed based on measured and/or received average load capacity values. According to an embodiment of the invention the lower bound reference value T (u,min) is computed based on at least average load capacity values comprising at least average radio resource utilization L (u) in the system (within adjacent cells) and average resource utilization fluctuation F (u,sys) in the system. According to an embodiment of the invention the upper bound reference value T (u,max) is defined based on scheduler performance. Then in step 1103 the initial estimate for the threshold T (u,est) is computed based on average, instantaneous and/or maximum load capacity values of resource utilization U measurements. According to an embodiment of the invention T (u,est) is computed based on at least one of the following values: T (u,max), T (u,min), F (u,sys) and F (max). Values of T (u,max), T (u,min) and F (u,sys) are according to the previous step and F (max) is the maximum fluctuation value that will be discussed later with reference to FIG. 12a. Then in step 1105 the initial threshold T (u,est) is tuned and computed based on instantaneous and/or maximum load capacity values of resource utilization U measurements. According to an embodiment of the invention T (u,est) is tuned based on at least one of the following values: number of handovers h versus number of maximum handovers h (max), resource utilization fluctuation F (u) in the base station, packet delay dt versus maximum packet delay dt (max) per traffic class, and number of packet drops r versus number of maximum packet drops r (max) for traffic class. For example a single peak in resource utilization fluctuation contributes to F (u) value. In addition to having a hysteresis margin in terms of resource utilization a triggering delay td (a kind of a “time hysteresis”) could be used and tuned in relations to the above mentioned values. In a similar way as with the resource utilization hysteresis margin, a longer triggering delay for the delay sensitive classes could be used enabling even better mitigation of premature reaction. Finally step 1107 shows the threshold T (u) for load balancing triggering that is used for the rest of the periodic cycle if no further tuning is required. An example of setting T (u) in relation to resource utilization load capacity is depicted in FIG. 13

In a method according to an embodiment of the invention multiple thresholds are set in relation to load capacity of resource reservation R in the base station and in the system. In step 1101 a lower bound reference value T (r,min) and an upper bound reference value T (r,max) are computed based on measured and/or received average load capacity values. According to an embodiment of the invention the lower bound reference value T (r,min) is computed based on at least average load capacity values 10 comprising at least average radio resource reservation L (r) in the system (within adjacent cells) and average resource reservation fluctuation F (r,sys) in the system. F (r,sys) depends on service flow arrivals/departures and MCS changes. According to an embodiment of the invention the upper bound reference value T (r,max) is defined to be a guard band G. Further in step 1101 there is calculated a number of reserved slots N in balanced state based on an average holding time of a slot t (s) and an average arrival rate of new slot reservations λ (res) as will be described later. Then in step 1103 the initial estimate for the threshold T (r,est) is computed based on average, instantaneous and/or maximum load capacity values of resource reservation R measurements. According to an embodiment of the invention T (r,est) is computed based on at least on of the following values: T (r,max) (=G), N, λ (res) and λ (reT). Values of T (r,max), N and λ (res) are according to the previous step and λ (reT) indicates the rate at which the load balancing scheme is able to release slots that will be discussed later. Then in step 1105 the initial threshold T (r,est) is tuned and computed based on more instantaneous and/or maximum load capacity values of resource reservation R measurements and the above-mentioned boundary values T (r,max) (=G) and T (r,min). According to an embodiment of the invention T (r,est) is tuned based on at least on of the following values: number of handovers h versus number of maximum handovers h (max), resource reservation fluctuation F (r) in the base station, slot releasing rate λ (rel), queueing q versus maximum queueing q (max), call blocking b versus maximum call blocking b (max), slot reservation rate λ (res) and slot holding time t (s). For example high values of h, F (r) or λ (reT) delays the threshold T (r,est) and high values of b, q, λ (res) and t (s) advances the threshold T (r,est). For example a single peak in resource reservation fluctuation contributes to F (r) value. Finally step 1107 shows the threshold T (r) for load balancing triggering that is used for the rest of the periodic cycle if no further tuning is required.

In a method according to an embodiment of the invention multiple thresholds are set in relation to load capacity of both resource utilization U and resource reservation R in the base station and in the system. As earlier discussed with reference to FIG. 6 a combination of these two schemes in load balancing triggering reduce the number of handovers conducted for delay sensitive connections while at the same time utilize the system wide resources in an efficient way.

As an example FIG. 13 depicts a flow diagram of a method for tuning and computing multiple thresholds on resource utilization level U according to an embodiment of the invention. This exemplary flow diagram describes further phases that step 1105 of FIG. 11 may comprise. In step 1301 of FIG. 13 the initial threshold T (u,est) has been computed according to steps 1101 and 1103 of FIG. 11 based on inter alia the lower and upper boundary values T (u,min) and T (u,max). In step 1301 instantaneous system resource utilization measurements are also available. An exemplary framework to compute and tune the resource utilization triggering thresholds T (u) for different traffic classes, e.g. T (u,nrt) for non-real-time and T (u,rt) for real-time traffic classes will be based on the load condition parameter, e.g. the average radio resource utilization L in the system and certain load condition variables per each traffic class to define a traffic-class-specific variable, e.g. the hysteresis margin dL, as described earlier. How much unbalance the radio system will tolerate depends on the traffic-class-specific variable. This tolerance is achieved by tuning the threshold T (u,est) taking into account the hysteresis margin dL accordingly. The the threshold T (u,est) can be tuned on the basis of following variables: average resource utilization fluctuation F locally and system wide, number of handovers h, packets experience delay dt and number of packet drops r and performance of the scheduler. The effects of these variables are: the higher fluctuation F the higher hysteresis margin dL, if maximum number of handovers h (max) is passed then the hysteresis margin dL must be larger, and if maximum packet delay dt (max) and maximum number of packet drops r (max) are passed then the hysteresis margin dL must be reduced. In accordance to above in step 1303 of FIG. 13, there is checked whether the traffic is very variable and the modulation and coding schemes (MCSs) change rapidly. If rapid changes occur then in step 1305 there is checked whether a single high resource utilization peak has been measured. Steps 1303 and 1305 guarantee that too premature reaction to rapid changes or single peaks will be prevented. However, if rapid changes occur and it is not question of the single peak in resource utilization U, then in step 1307 the hysteresis margin dL is set larger and in step 1309 the triggering delay td is made longer. On the other hand if in step 1303 the traffic fluctuation F is found steady (no rapid changes) and in step 1311 packet drops r are not detected, then there is no need to tune the threshold T (u). However, if in step 1311 packet drops r are detected, then in step 1313 the hysteresis margin dL will be reduced and in step 1315 the triggering delay td will be made shorter. In step 1316 an instant estimation of tuned threshold T (u,est) will be set. Next in step 1317 there is checked whether the number of handovers h is reduced and is below the value h (max). If the answer is “no” then in step 1307 the hysteresis margin dL is made larger and in step 1309 the triggering delay td is made larger. If the answer is “yes” then in step 1319 there is checked whether the number of packet drops r is reduced and is below the value r (max). Also overlong packet delays dt can be used as a decision criteria in this stage. If the answer is “no” then in step 1313 the hysteresis margin dL is reduced and in step 1315 the triggering delay td is reduced. If the answer is “yes” then in step 1320 there is checked whether the estimated value of T (u,est) is below or equal to the upper bound value T (u,max) received from step 1101 of FIG. 11. If not then T (u,est) is rejected (not shown). Also the lower bound value T (u,min) or both the bound values can be checked in step 1320. Finally, after tuning cycles if the answer in step 1320 is “yes” then in step 1321 there is as a result the resource utilization triggering threshold T (u) for the traffic class. Correspondingly multiple thresholds are tuned by repeating steps 1301-1321 for each traffic class differentiated in accordance to the step of differentiating.

An example of calculating multiple thresholds is presented in FIGS. 12a and 12b. Lets exemplary characterize the average system resource utilization fluctuation F (u,sys) to range from 0 to a maximum of 255. The minimum value 0 would correspond to a traffic mixture of VoIP connections with steady channel conditions and the maximum 255 would correspond to a traffic mixture of highly varying traffic sources with varying channel conditions. In other words the more mobile the served terminals are and the more variable traffic they have, the higher value will be reported. If resource utilization U and radio resource fluctuation F (u) measurements are communicated between the BSs, a resource utilization threshold T (u) can be computed periodically with equation (1):

As shown in FIG. 12a in the beginning two boundary values, namely a lower bound reference value T (u,min) and an upper bound reference value T (u,max) are set in order to automatically compute the triggering threshold T (u). The lower boundary value T (u,min) includes a minimum hysteresis margin dL required to avoid the ping-pong effect resulting from one BS initiating and another BS accepting too many load balancing handovers. This is called the handover based ping-pong effect. Note that this ping-pong effect caused by the user terminals being handed over is different from the ping-pong effect caused by general resource utilization fluctuation that is called the fluctuation based ping-pong effect. The former is caused by incorrect estimates of the number and resource utilization of the user terminals that are handed over and accepted and the latter by all traffic and channel fluctuation in the base stations. T (u,min) can be set in relations to the average system load capacity L and average system radio resource fluctuation F (u,sys), and will increase as F (u,sys) increases. F (u,sys) can be calculated based on the values received from the spare capacity report (SCR) of adjacent base stations thus describing the overall fluctuating nature of the incoming traffic. The upper bound reference value T (u,max) is based on the reliability and performance of the scheduler and denotes the maximum value for the triggering threshold T (u) after which the service of the existing connections starts to degrade. A new resource utilization threshold T (u) can be computed every load balancing cycle. The threshold T (u) is a function of T (u,max), T (u,min) and F (u,sys). One way to set the threshold T (u) can be made by computing periodically the following equation (1):

T(u)=T(u,min)+(T(u,max)−T(u,min))·F(u,sys)/F(max) (1)

where F (max) is the maximum fluctuation value 255 as already discussed above. As can be seen, as the system fluctuation F (u,sys) increases the size of the hysteresis margin increases so that the system won't react prematurely to the varying traffic. Both the lower boundary value T (u,min) and resulting threshold T (u) can be reactively tuned in relations to maximum value for the number of handovers per user terminal h (max). The resulting threshold T (u) can also be tuned in relations to the maximum value for the number of dropped packets r (max) and overlong packet delays dt (max).

This scheme is used as a basis when computing multiple triggering thresholds. In case referring to FIG. 12b an example of two traffic classes (real-time (rt) and non-real-time (nrt)) are presented in order to set and tune load balancing triggering thresholds T (u,nrt) and T (u,rt). To make the real-time connections most robust against traffic fluctuation the load balancing triggering threshold T (u,rt) for realtime traffic class is set to be the same as defined in equation (1) above, i.e. T (u,rt)=T (u). Automatic tuning will now also be based on T (u,min) as shown in FIG. 12b. The threshold T (u,nrt) for the non-real-time traffic class is set in accordance to the following equation (2):

T(u,nrt)=T(u,min)+(T(u)−T(u,min))·h(sen)/h(nrt) (2)

Symbol h (sen) is the maximum handover rate allowed for the most delay sensitive class and the thresholds T (u,nrt) are calculated in relations to it so that the delay sensitive class will result in a higher threshold than the delay tolerant. For its part h (nrt) corresponds to the maximum handovers allowed per minute for the non-real-time class. The threshold T (u,nrt) is a function of h (nrt), h (sen), T (u) and T (u,min) as described above. For example if h (sen)=h (rt)=1 handover/minute and h (nrt)=5 handovers/minute then T (u,rt)=T (u,min)+(T (u)−T (u,min))× 1/1 and T (u,nrt)=T (u,min)+(T (u)−T (u,min))×⅕.

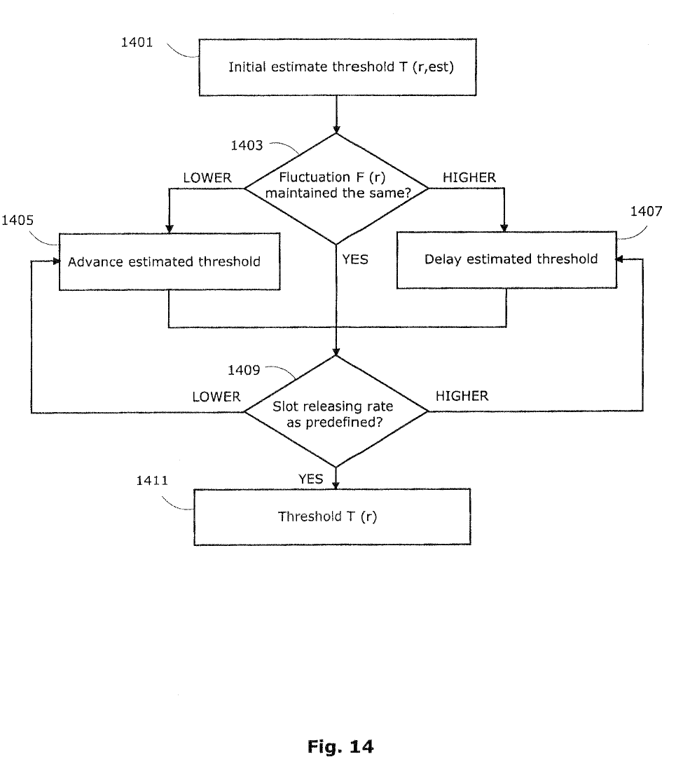

As an example FIG. 14 depicts a flow diagram of a method for tuning and computing multiple thresholds on resource reservation R level according to an embodiment of the invention. This exemplary flow diagram describes further phases that step 1105 of FIG. 11 may comprise. In step 1401 of FIG. 14 the initial threshold T (r,est) has been computed according to steps 1101 and 1103 of FIG. 11 based on inter alia the lower and upper boundary values T (r,min) and T (r,max) In step 1401 instantaneous system resource reservation measurements are available. An exemplary framework to compute and tune the resource reservation triggering thresholds T (r) for different traffic classes, e.g. T (r,rt) for non-real-time and T (r,ho) for realtime traffic classes (as shown in FIG. 9) will be based on the load condition parameter comprising certain load condition variables per each traffic class to define a traffic-class-specific variable, preferably a guard band G, intended to protect rescue handover connections. The guard band G per traffic class is reserved in order to avoid arriving new and/or handover connection blocking. The value of G is used as T (r,max). Based on measurement results e.g. an average arrival rate of new slot reservations λ (res) and an average holding time of slot t (s) a number of reserved slots N when the radio system is in balance is calculated using Little's formula which will be used for the initial threshold estimate T (r,est). To further tune the threshold in step 1403 a check is made whether the fluctuation F (r) in resource reservation has changed e.g. due to MCS changes. If fluctuation F (r) has become lower the estimated threshold T (r,est) is advanced in step 1405. If fluctuation F (r) has become higher the estimated threshold T (r,est) is delayed in step 1407. If the fluctuation F (r) has stayed the same no tuning will be done. Next in step 1409 a check is made whether, λ (rel), the rate at which the load balancing scheme can release slots is as predefined. If it is lower than before threshold T (r,est) is advanced in step 1405. If it is higher than before the instant estimated threshold T (r,est) is delayed in step 1407. If it has not changed in step 1409 the threshold T (r) is set to be the load balancing triggering threshold for the rest of the cycle in step 1411. The estimated threshold T (r,est) can also be reactively tuned in relation to the maximum call blockin rate b (max) indicating the case where handovers were triggered too late (not shown) and unnecessary handover rate h (max) indicating when handovers were triggered too early (not shown). Correspondingly multiple thresholds are tuned by repeating steps 1401-1411 for each traffic class differentiated in accordance to the step of differentiating for existing, new and handover traffic connections.

An example of calculating multiple thresholds is presented. If λ (res) is the average arrival rate of new slot reservations and t (s) is the average holding time of a slot, using Little's formula the number of reserved slots N when the radio system is balanced can be calculated periodically with the following equation (3):

N=λ(res)·t(s) (3)

This number N can be used to compute an estimation of a threshold T (r,est) for triggering load balancing in relations to current resource reservation R with the following equation (4):

T(r,est)=G−(N−G)·λ(res)/λ(rel) (4)

where λ (rel) indicates the rate at which the load balancing scheme can release slots. As can be seen the higher N and the lower λ (rel) are the earlier load balancing will be triggered. Since measurements can be inaccurate, the load balancing should be set to trigger at latest when resource reservation R reaches G and hence the final triggering threshold T (r) will be as shown in equation (5):

T(r)=min (T(r,est), G) (5)

The load balancing should be triggered before G is reached, but not too early to avoid unnecessary handovers. The value of λ (rel) depends on cell-reselection and the handover mechanisms used. Since the handover guard band G might also vary, threshold setting can be a challenging task. The threshold could be further reactively tuned in relations to a maximum call blocking rate value b (max) indicating the case where handovers were triggered too late and unnecessary handover rate value h (max) indicating when handovers were triggered too early. This scheme is applicable to the new real-time (rt) connection guard band threshold and non-real-time (nrt) handover guard band threshold discussed in association to FIGS. 8a, 8b and 9. In the scheme crossing the threshold protecting new real-time connections will cause new non-real-time connection blocking and crossing the threshold protecting rescue handover non-real-time connections will cause blocking of new real-time connections. By applying the equations (3)-(5) to these two, two resource reservation thresholds T (r,rt) and T (r,ho) (as shown in FIG. 9) can be determined, which thresholds define when resource reservation R based load balancing should be triggered for each of the traffic classes. The slot release rate λ (rel) will be different for each of the traffic classes, namely λ (rel,nrt) and λ (rel,rt) since different handover mechanisms are used for the traffic classes.

A method for load balancing triggering according to embodiments of FIGS. 4 and 6 of the invention can be exemplary applied to Mobile WiMAX communication networks. Following considerations have to be taken into account in this case. Firstly, because Mobile WiMAX has an admission control mechanism that protects the existing connections, new service flows could be admitted also in the overloaded state. Functionality of admission control and scheduling within radio system takes care of scheduling and buffering of different traffic classes in accordance to traffic prioritization. In prior art load balancing scheme described in the background section of this application with reference to FIG. 2b denies in the overloaded state admission of new connections in service flow level and directed handover connections. Secondly, the scanning process, where the user terminal monitors adjacent cells (and BSs) to determine suitability of the BSs for establishing connection, allows load condition variable comprising information on radio distance, round trip delay and location estimation to be used in recognition of the user terminals residing in the overlapping areas within the cells. Thirdly, the scanning process allows load condition variable comprising information on channel and round trip delay variation that can be used to discover whether the user terminal is static or mobile, i.e. does it remain in the overlapping area during the whole connection or not. Fourthly, the number of user terminals that should be handed over to attain average load can be calculated.

FIG. 15 depicts a flow diagram of a method according to an embodiment of the invention for recognizing at least one static user terminal among plurality of user terminals 322a, 322b, 324a, 324b residing in the overlapping area. After initiating load balancing the BS will have to find out which user terminals are static and in the overlapping area. If in step 1501 no ready list exists of these user terminals they have to be discovered before directed handovers can be initiated. To reduce unnecessary scanning step 1505 is used to narrow down the candidate user terminals to those ones that are static and likely to reside in the overlapping area. This could be done by using measurements on channel variation, signal strength, round trip delay and also by using location estimation methods. In step 1507 cell re-selection procedure is initiated for the remaining user terminals. In Mobile WiMAX this can be done by sending them e.g. unsolicited MOB SCN-RSP messages telling them to scan all neighbor BSs based on the information received in the MOB NBR-ADV message. The results could be reported via the radio interface from the user terminal to the serving BS (SBS), or with the physical parameters report from the target BS (TBS) to the serving BS. Based on the results a list of user terminals that are in the overlapping area (within the signal range of at least two adjacent BSs) will be generated in step 1507. Also the set of target BSs with feasible signal strengths will be recorded for each user terminal. If the list of overlapping static user terminals is kept before load balancing is triggered it can be based on a similar procedure. After the list of static user terminals in the overlapping area is ready, in step 1509 the list can be further pruned and the user terminals in the list can be prioritized. For example the user terminal that have candidate target BS sets where none of the target BSs are in an underloaded state can be removed. When conducting directed handovers, the target BSs might eventually go to the balanced state and will start to deny incoming directed handovers. The user terminals that will be handed over can also be prioritized based on traffic priority, their radio distance, physical service level in the target BS or resulting interference. The per QoS profile spare capacity reporting (SCR) procedure can also be used for decision support. After prioritization of user terminals has been done the they can be grouped so that handovers can be executed in parallel. The next user terminal (or a group of user terminals) from the list will be handed over until the end of the list has been reached, the new resulting resource utilization new_avg_U is equal or below the average resource utilization L, or the end of the load balancing cycle has been reached according to step 1513. The new resulting resource utilization new_avg_U can be calculated using the average resource utilization of the released service flow. The reason that the current resource utilization measurement is not used is that the effect of the released resources won't be necessarily shown immediately in the measurements because they are averaged. A similar problem can occur in the target BS, where the new service flow will be created. To reduce the possibility for a resulting handover handover based ping-pong effect, an estimation of the average resource utilization of the new flow can be added to the measured average resource utilization L.

Differentiating between rescue and directed handovers when requesting the permission for a handover from the less congested target BS in a distributed system is discussed. Distributed system means that handover decisions are made locally in each base station. Possible changes to the handover request (HO_req) message HO_type field in the Mobile WiMAX architecture are suggested. Such distinction would be especially beneficial in a distributed architecture such as Mobile WiMAX (if a centralized element (such as an RNC) is involved that initiates the handovers this is not so critical). A distinction between rescue handovers and BS directed handovers can be made so that they can be treated differently by the target BS. Rescue handovers will be admitted in all loading states but directed handovers only in the underloaded state. BS directed handovers are thus allowed if instant load capacity in the cell is below or equal to average load capacity in the system. As discussed before to make the load balancing logic work in Mobile WiMAX, it would be also beneficial to specify in the HO req message, whether the handover in question is a rescue or a directed handover. Furthermore, a differentiation between a resource utilization based directed handover and a resource reservation based directed handover could be made to enable different treatment. The remaining bits in the fields that the handover type (e.g. HO type in Mobile WiMAX HO req message) could be used for these differentiations.

A method for load balancing triggering according to embodiments of FIGS. 5 and 6 of the invention can be exemplary applied to Mobile WiMAX communication networks. Considering a situation in FIG. 9 wherein all the resources reserved R of the BS are used even after load balancing has been conducted at the triggering threshold T (r,ho) and the instant resources reserved R has increased above the guard band G (nrt,ho) limit. Under these conditions, if the user terminal residing in the overlapping area is trying to establish a connection and is blocked, it will eventually try to enter another BS. This might however take a long time. However, if all the resources reserved R of the BS are used after load balancing has been conducted then a directed retry can be used for the BS to explicitly direct the blocked connection to another BS. Directed retry is started for those user terminals in the overlapping areas whose new connection was rejected. When the BS is assisting the user terminal in the redirection, network entering and connection establishment can be done much faster because similar pre-associations and backbone pre-negotiations can be conducted as with a regular handover. Direct retry can be thought of as a directed handover for a connection that hasn't even been established. On the other hand a network directed roaming is started for those user terminals in the non-overlapping areas whose new connection was rejected. Network directed roaming can be used to direct user terminals that are not in the overlapping area and whose connection is blocked, to the nearest access point having most free capacity. In other words the BS would give the user terminal co-ordinates where another access point is located. Both directed retry and network directed roaming can be used in Mobile WiMAX with few modifications to the initial network entry procedures.

To make directed retry and network directed roaming work in Mobile WiMAX a few modifications to the initial network entry procedures should be made. When blocking occurs in a BS, a dynamic service addition response message (DSA_RSP) could be sent to the user terminal initiating the service flow with an indication that directed retry or network directed roaming could be conducted. After that a discovery process to find out if the user terminal is in the overlapping area could be carried out resulting in a directed handover if the user terminal is residing in the overlapping area. Network directed roaming would be conducted as a last resort for the user terminal that is not in the overlapping area by communicating a location of the closest lightly loaded adjacent BS. This can be included in the DSA RSP or MOB NBR-ADV message. This requires co-operation with application level protocols.

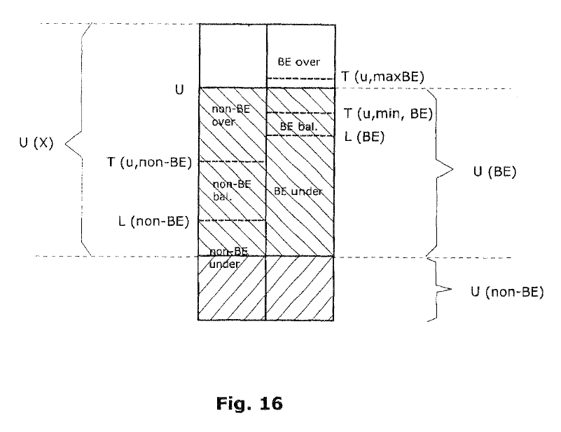

As an example of a method for load balancing triggering according to embodiments of FIG. 4 of the invention is presented that can be applied to Mobile WiMAX communication networks. In the WiMAX Forum network architecture, load balancing is supported only for non-best-effort (non-BE) services meaning that best-effort (BE) user terminals are responsible for conducting load balancing themselves. However, resource utilization U load balancing triggering according to the invention can be applied for BE user terminals as exemplary shown in FIG. 16. Since resources are first utilized by non-BE user terminals, BE user terminals will use whatever is left. This means that the available resources for BE traffic varies. In FIG. 16 reference U (non-BE) denotes instantaneous utilized resources for non-BE traffic and U (BE) instant resource utilization for BE traffic, because (total) instant resource utilization U is separated for non-BE and BE traffic as shown. U (X) denotes all resources that is left over for BE traffic after non-BE traffic resource utilization U (non-BE). L (non-BE) denotes an average system resource utilization for non-BE traffic being an upper limit for non-BE underloaded state. T (u,non-BE) denotes triggering threshold for non-BE traffic and is an upper limit for non-BE balanced state. Correspondingly L (non-BE) and T (u,BE) denote average resource utilization and triggering threshold for BE traffic. According to steps 403-407 of FIG. 4 same loading states, i.e. underloaded, balanced and overloaded, can be computed for the BS in terms of BE user terminals if the load capacity information (free resources and used resources) of BE user terminals is communicated between the BSs (currently not done in e.g. Mobile WiMAX). If another BS has a large amount of resources available in BE underloaded state for BE user terminals, some of the BE user terminals can be handed over to that BS. Since the resources U (X) available for BE traffic depends on the resource utilization U (non-BE) of non-BE user terminals the load capacity BE connections get might vary considerably. Also the fact that BE traffic is often very fluctuating further increases variability in estimating the load capacity information. Hence it might be beneficial to use a longer averaging time to measure the BE resource utilization U (BE) and resources available for BE traffic U (X). Still the averaging time should be such that the system is able to react quickly to changes. Since handovers aren't such a critical issue for the BE traffic the setting of the threshold T (u,BE) for load balancing triggering could be more opportunistic than setting threshold T (u,non-BE) with non-BE connections. Therefore the hysteresis margin dL (BE) for BE traffic could be set so, that load balancing would be triggered earlier so that BE user terminals would able to benefit from the BSs that have most load capacity. The resource utilization thresholds T (u,BE) and T (u,non-BE) can be tuned in accordance to a procedure shown in FIG. 11. Here a smaller hysteresis margin dL (BE) can be set by using a lower upper boundary reference value T (u,max,BE), and a high value for the allowed number of handovers per user terminal h (max,BE) and a low value for packet drops d (max,BE) and maximum delays r (max,BE). A corresponding lower boundary reference value T (u,min,BE) can also be set to mitigate the handover based ping-pong effect. For example in Mobile WiMAX if load balancing with handovers would be supported in the user terminals the delay increases experienced by e.g. BE FTP and HTTP connections could result in user terminal initiated load balancing based handovers for the BE user terminals. Furthermore if the additional fields to communicate BE resource utilization would be implemented, also the BS could initiate directed handovers for the BE user terminal enabling BS initiated BE load balancing. This would be better than user terminal initiated load balancing because the BS would have more information and would also know what would be the best target Base Station (TBS) for the user terminal to handover to, in terms of available bandwidth for the BE user terminals and the number of other BE user terminals contending for it in the candidate TBSs.

As an example of an embodiment of the invention load condition variables comprising GPS routing information can be used for reserving resources for handovers. In the next generation mobile networks, cars will have real-time connections and while driving and moving from cell to cell many handovers will occur for the connections. Guaranteeing a zero handover dropping probability has proven to be very expensive when the route that the mobile user terminal is going to traverse is not known. Hence usually only a maximum dropping probability is guaranteed. In the future, the usage of GPS navigation systems will become more and more common. Since cars with embedded computing systems will become mobile user terminals themselves, information of the planned route that the GPS navigation system calculates, based on the destination input given by the driver, can be sent to the access network. If such information on the route that the mobile user terminal is going to traverse is available, resources for handovers could be reserved in advance enabling more efficient resource utilization, better QoS and lower costs for the operator.

Due to the flexible nature of Mobile WiMAX, dynamic guard band adaptation based on mobility and traffic intensity in the adjacent BSs is a natural choice as a basis for handover prioritization. Since efficient resource utilization is a crucial issue in Mobile WiMAX we don't want the guard band to be too conservative. Therefore a scheme that uses some kind of an initial prediction for the guard band and then reactively adapts it, based on how QoS guarantees, such as handover dropping rate, are fulfilled could be good for Mobile WiMAX. Such an approach would also be very simple.

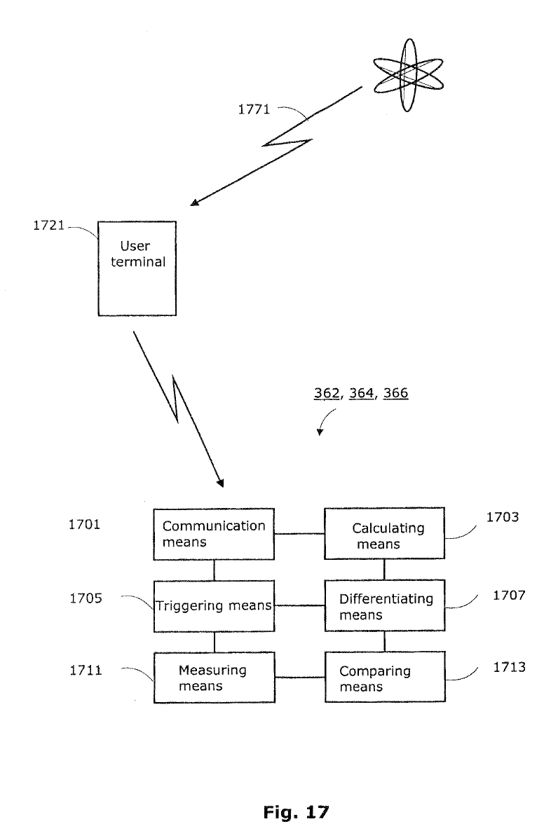

Referring to exemplary block diagrams of FIGS. 3 and 17, a system and a network element according to some embodiments of the invention is described. It should be noted that all featured element blocks are not necessarily needed in every embodiment and that the order in which the element blocks are presented may vary.

A system for balancing load according to the invention is depicted in FIG. 3. The system for balancing load in a cellular network comprises a plurality of base stations 312, 314, 316, where each base station provides a cell 302, 304, 306 for transmitting to and receiving from at least one user terminal. The system is arranged to measure periodically load capacity of each adjacent cell 302, 304, 306 overlapping at least partly within the plurality of cells, where at least one user terminal 322a, 322b, 324a, 324b resides in an overlapping area of said adjacent cells 302, 304, 306. The system is arranged to differentiate traffic connections of said at least one user terminal 322a, 322b, 324a, 324b within each cell to at least two traffic classes based on at least delay sensitivity of the connection. The system is arranged to compare the load capacities in each of adjacent cells 302, 304, 306, and within the adjacent cells 302, 304, 306, where said at least one user terminal 322a, 322b, 324a, 324b resides in the overlapping area of said adjacent cells, to define at least one load condition parameter in each of the adjacent cells. The system is arranged to set a threshold for each of said traffic classes in relation to the load condition parameter and trigger, upon extending the threshold, the traffic class having lower delay sensitivity before the traffic class having higher delay sensitivity to handle the connection of the user terminal 322a, 322b, 324a, 324b further. In a system according to an embodiment of the invention the system is arranged to set a threshold for each of said traffic classes in relation to the load condition parameter for a load balancing cycle and is arranged to recognize at least one static user terminal from said plurality of the user terminals 322a, 322b, 324a, 324b likely residing in the overlapping area throughout their whole session. Load balancing handovers should be made for the user terminals that are not likely to leave from the overlapping area, i.e. the user terminals that reside in the overlapping area for a lot longer time than the load balancing cycle. After this the system is arranged to trigger, upon extending the threshold, the traffic class having lower delay sensitivity before the traffic class having higher delay sensitivity to handle the connection of the static user terminal 322a, 322b, 324a, 324b further, e.g. performing cell reselection of the static user terminal.

In a system according to an embodiment of the invention as shown in FIG. 17 each base station 312, 314, 316 comprises a network element, e.g. logic entity 362, 364, 366 that is arranged to communicate the load capacity and load condition parameter between the base stations 312, 314, 316 by communicating means 1701 comprising at least a receiver or transceiver (not shown). The logic entity 362, 364, 366 optionally comprises measuring means 1711 arranged to measure periodically, e.g. in the beginning of a periodic cycle, load capacity of the cell or alternatively it receives results of load capacity measurement from the base station controller 350. The logic entity 362, 364, 366 comprises calculating means 1703, e.g. a controller, configured to compute and tune thresholds for load balancing triggering according to the invention. The logic entity 362, 364, 366 comprises comparing means 1713 arranged to compare the load capacities in each of adjacent cells 302, 304, 306, where said plurality of user terminals 322a, 322b, 324a, 324b reside in the overlapping area of said adjacent cells, to define in each of the adjacent cells 302, 304, 306 a load condition parameter comprising at least one load condition variable relating to the traffic class. The logic entity 362, 364, 366 comprises triggering means 1705 arranged to trigger upon exceeding the threshold the traffic class having lower delay sensitivity before the traffic class having higher delay sensitivity to handle a connection of the user terminal further. The logic entity 362, 364, 366 comprises differentiating means 1707 arrange to differentiate traffic connections within the cell to at least two traffic classes based on at least delay sensitivity of the connection. The logic entity 362, 364, 366 is arranged to communicate with admission controller and scheduler of the base station 312, 314, 316. Alternatively, the logic entity 362, 364, 366 comprises means for admission control and scheduling (not shown).

In a network element according to an embodiment of the invention the network element, preferably a logic entity 362, 364, 366, comprises means for recognizing at least one static user terminal from said plurality of the user terminals 322a, 322b, 324a, 324b likely residing in the overlapping area throughout their whole session. Alternatively, the comparing means 1713 is arranged to recognize at least one static user terminal or the calculating means 1703 is arranged to recognize at least one static user terminal from said plurality of the user terminals 322a, 322b, 324a, 324b residing in the overlapping area. The network element comprising communicating means 1701 is arranged to communicate between the base stations 312, 314, 316 information on average and instantaneous load capacity, changes in load capacity and load condition parameter both in the radio system level (adjacent cells) and locally in the cell level. The communicating means 1701 comprises a transmitter-receiver (not shown) arranged to send and receive messages comprising above mentioned load capacity information. In a network element according to an embodiment of the invention the network element comprising communicating means 1701 is arranged to communicate with the user terminals 322a, 322b, 324a, 324b residing in the overlapping area.

In a network element according an embodiment of the invention the network element, preferably the logic entity 362, 364, 366, is arranged to send and receive messages comprising reports relating to load capacity measurements such as spare capacity report (SCR) or other such reports. Further the network element, preferably the logic entity 362, 364, 366, is arranged to send to user terminals 322a, 322b, 324a, 324b and receive from user terminals 322a, 322b, 324a, 324b messages comprising information relating to load capacity such as DSA_RSP messages, MOB NBR-ADV messages, unsolicited MOB SCN-RSP messages, etc. in order to recognize static user terminals in the overlapping area or initiate network directed retry handovers and network directed roaming e.g. in Mobile WiMAX system as described earlier in this application. Additional fields relating to the load condition parameter can be added to messages communicated between the adjacent base stations and/or the base station and the user terminals 322a, 322b, 324a, 324b residing in the overlapping area.

In a network element according an embodiment of the invention the network element, preferably the logic entity 362, 364, 366, resides in a radio resource agent (RRA) entity of the base station according to the Mobile WiMAX network architecture.

Referring to FIG. 17 in a system according to an embodiment of the invention the system comprises positioning means for defining a location of a user terminal 1721. The positioning means comprise in the user terminal 1721 a positioning module that is able to define the location of the user terminal 1721 on the basis of positioning signals 1771 that are received from a navigation system. The positioning module of the user terminal can be arranged to operate with the navigation system based on e.g. the US Global Positioning System (GPS). In a system according to an embodiment of the invention the user terminal 1721 moving from cell to cell and receiving GPS location and/or routing information from the navigation system to its positioning module can transmit the routing information to the communication means 1701 of the logic entity 362, 364, 366. Then the logic entity 362, 364, 366 comprising calculating means 1703, differentiating means 1707, comparing means 1713 and triggering means 1705 is able to set multiple thresholds for load balancing triggering in relation to the the load condition parameter comprising location and/or routing information so that resources for handovers can be reserved preferably in advance.

A computer program product according to an embodiment of the invention comprises software routines for enabling a programmable processor to access a load capacity measurement database arranged to store a plurality of data items associated with at least load capacity, changes in load capacity and/or load condition parameter both in the adjacent cells (system) and locally in the cell, information about which can be provided between the adjacent cells and between the cell and the user terminal. The computer program product comprises software routines for making the programmable processor to control and perform at least some of the operations described in association with a network element according to an embodiment of the invention depicted in FIG. 17. A computer program product according to an embodiment of the invention is embodied in a processor 1703 of the network element. A computer program product according to an embodiment of the invention can also be embodied in a signal transferred in a data communication network, e.g. the Mobile WiMAX network.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is intention, therefore, to be limited only as indicated by scope of the claims appended hereto.

1. A method for balancing load in a cellular network comprising a plurality of cells, the method comprising:
measuring periodically load capacity of each adjacent cell overlapping at least partly within the plurality of cells, where at least one user terminal resides in an overlapping area of said adjacent cells,
differentiating traffic connections of said at least one user terminal within each cell to at least two traffic classes based on at least delay sensitivity of the connection,
comparing the load capacities in each of adjacent cells, where said at least one user terminal resides in the overlapping area of said adjacent cells, to define in each of the adjacent cells a load condition parameter comprising at least one load condition variable relating to the traffic class,
setting a threshold for each of said traffic classes in relation to the load condition parameter, and
triggering, upon extending the threshold, the traffic class having lower delay sensitivity before the traffic class having higher delay sensitivity to handle the connection of the user terminal further.

2. The method according to claim 1, wherein the load capacity refers to instantaneous utilized resources in each cell and the load condition parameter comprises an average resource utilization within each of said adjacent cells.

3. The method according to claim 2, wherein the load condition parameter comprises load condition variables relating to changes in the resource utilization within each of said traffic classes in order to calculate a traffic-class-specific hysteresis margin.

4. The method according to claim 3, wherein the traffic-class-specific hysteresis margin increases due to increasing changes in the average resource utilization.

5. The method according to claim 3, wherein the traffic-class-specific hysteresis margin is defined based on the load condition variables comprising at least one of the following variables: a number of handovers per user terminal, packet delay per traffic class, packet drops per traffic class, radio resource fluctuation and scheduler performance.

6. The method according to claim 1, wherein an upper reference value determining a maximum value for the threshold is calculated based on at least scheduler performance.

7. The method according to claim 1, wherein an upper reference value determining a maximum value for the threshold is calculated based on at least a guard band reserved for incoming handover connections.

8. The method according to claim 1, wherein a lower reference value determining a minimum value for the threshold is calculated based on at least the load condition variables comprising average resource utilization in the system and resource utilization fluctuation in the cell.

9. The method according to claim 1, wherein a lower reference value determining a minimum value for the threshold is calculated based on at least the load condition variables comprising average resource reservation in the system and resource reservation fluctuation in the cell.

10. The method according to claim 1, wherein the differentiating traffic connections further comprises differentiating traffic connections within each traffic class.

11. The method according to claim 1, wherein the load capacity refers to reserved resources of each cell and the load condition parameter comprises instantaneous reserved resources within each of said adjacent cells.

12. The method according to claim 11, wherein the load condition parameter comprises load condition variables relating to changes in the resource reservation within each of said traffic classes in order to calculate at least one traffic-class-specific guard band reserved for incoming new and handover traffic connections of the user terminal within each of said adjacent cells.

13. The method according to claim 12, wherein the guard band dynamically depends on arrival rate of the incoming new and handover traffic connections and a period of time of the whole traffic connection of the user terminal.

14. The method according to claim 1, wherein the load condition parameter comprises at least information on load capacity changes in the radio system and load capacity changes locally in the cell.

15. The method according to claim 11, wherein the differentiating traffic connections further comprises differentiating new and handover traffic connections within each traffic class.

16. The method according to claim 11, wherein the threshold is estimated based on the load condition parameter comprising at least one of the following variables: an average slot reservation rate, an average slot holding time, a slot release rate, resource reservation fluctuation, average resource reservation and a guard band.

17. The method according to claim 16, wherein the threshold is further estimated based on the load condition parameter comprising at least the following variables: a maximum call blocking rate, resource reservation fluctuation, load balancing slot release rate, queuing, instantaneous slot reservation rate, instantaneous holding time and a maximum number of handovers per user terminal.

18. The method according to claim 12, wherein the traffic-class-specific guard band determines a maximum value of the threshold.

19. The method according to claim 12, wherein the traffic-class-specific guard band is dynamically tuned according to mobility patterns of each cell.

20. The method according to claim 1, comprising communicating the load capacity and load condition parameter between the adjacent cells.

21. The method according to claim 1, wherein a first load capacity refers to first resources in each cell and a second load capacity refers to second resources in each cell and a first load condition parameter comprises an average first resources within each of said adjacent cells and a second load condition parameter comprises instantaneous second resources within each of said adjacent cells.

22. The method according to claim 3, wherein the load condition parameter comprises information about unused load capacity with respect to total load capacity in each of said adjacent cells, the hysteresis margin for a first traffic class is calculated based on the unused load capacity of a second traffic class.

23. The method according to claim 22, wherein the hysteresis margin is set smaller for best-effort connections and the hysteresis margin is set larger for non-best-effort connections.

24. The method according to claim 1, wherein the load condition parameter comprising location data of each of said adjacent cells is used to redirect a user terminal residing outside the overlapping area of said adjacent cells to perform cell reselection of said user terminal to another cell of said adjacent cells in accordance said location data.

25. The method according to claim 1, wherein the load condition parameter comprises vehicle routing information received from location navigation system to the user terminal connected to the location navigation system in order to reserve resources in advance to perform cell reselection of the user terminal.

26. The method according to claim 1, wherein handling the connection of the user terminal further comprises performing cell reselection of the user terminal.

27. The method according to claim 1, wherein handling the connection of the user terminal further comprises blocking an arriving new connection of the user terminal and redirecting it to another cell.

28. A method according to claim 1, wherein performing cell reselection of the user terminal is allowed if instantaneous load capacity in the cell is equal or below average load capacity in the adjacent cells.

29. A method according to claim 1, wherein performing cell reselection of the user terminal is based on differentiating traffic connections in relation to load capacity.

30. A method according to claim 29, wherein communicating a handover request message comprises information on differentiation between the base station initiated directed handover and the user terminal initiated rescue handover.

31. The method according to claim 1, wherein the user terminal resides in the overlapping area of said adjacent cells for the whole period of time of the traffic connection of the user terminal.

32. A method according to claim 31, wherein recognizing of the user terminal is based on at least one of the following variables relating to said adjacent cells: channel variations, signal strength, round trip delay and location information.

33. A method according to claim 31, comprising generating a list of user terminals based on scanning reports received by the adjacent cells after the at least one user terminal scanning the adjacent cells.

34. A method according to claim 33, wherein prioritizing the list of user terminals in accordance to at least one of the following variables: a traffic connection priority of the user terminal, radio distance between the user terminal and said adjacent cells and physical service level in said adjacent cells.

35. A method according to claim 34, wherein user terminals in the list are grouped to perform cell reselection in parallel.

36. A method according to claim 33, wherein cell reselection of the user terminal ends when the list of the user terminals ends, when an instant resource utilization is equal or below the average resource utilization or when the load balancing cycle ends.

37. A system for balancing load in a cellular network comprising a plurality of base stations, each base station providing a cell for transmitting to and receiving from at least one user terminal, wherein the system is arranged to:
measure periodically load capacity of each adjacent cell overlapping at least partly within the plurality of cells, where at least one user terminal resides in an overlapping area of said adjacent cells,
differentiate traffic connections of said at least one user terminal within each cell to at least two traffic classes based on at least delay sensitivity of the connection,
compare the load capacities in each of adjacent cells, where said at least one user terminal resides in the overlapping area of said adjacent cells, to define at least one load condition parameter in each of the adjacent cells,
set a threshold for each of said traffic classes in relation to the load condition parameter, and
trigger, upon extending the threshold, the traffic class having lower delay sensitivity before the traffic class having higher delay sensitivity to handle the connection of the user terminal further.

38. A system according to claim 37, wherein the user terminal residing in the overlapping area of said adjacent cells is being connected to the cell for the whole period of time of the traffic connection of the user terminal.

39. A network element for balancing load in a cellular network comprising a plurality of base stations, wherein each base station provides a cell for transmitting to and receiving from at least one user terminal, the network element comprising:
measuring means arranged to measure periodically loading capacity of each cell overlapping at least partly within the plurality of cells,
differentiating means arranged to differentiate traffic connections within each cell to at least two traffic classes based on at least delay sensitivity of the connection,
comparing means arranged to compare the loading capacities of adjacent cells, where at least one user terminal resides in an overlapping area of said adjacent cells, to define a load condition in each of the adjacent cells,
setting means to set a threshold for each of said traffic classes in relation to the load condition for a load balancing cycle,
the comparing means arranged to recognize at least one static user terminal from said plurality of the user terminals residing in the overlapping area throughout its whole session, and
triggering means arranged to trigger, upon extending the threshold, the traffic class having lower delay sensitivity before the traffic class having higher delay sensitivity to perform cell reselection of the static user terminal.

40. The network element according to claim 39, comprising communicating means arranged to communicate the load capacity and load condition parameter between the adjacent cells.

41. The network element according to claim 39, wherein network element resides in a radio resource agent entity.
